(19) United States
(12) Patent Application Publication
(10) Pub. No.: US 2026/0101361 A1
(43) Pub. Date: Apr. 9, 2026

(54) SCHEDULING AND RESOURCE RESERVATION FOR MULTI-SLOT TRANSMISSIONS

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Chih-Hao LIU, San Diego, CA (US); Xiaoxia ZHANG, San Diego, CA (US); Giovanni CHISCI, San Diego, CA (US); Shaozhen GUO, Beijing (CN); Siyi CHEN, Beijing (CN); Hao XU, Beijing (CN)

(21) Appl. No.: 19/112,191

(22) PCT Filed: Oct. 27, 2022
(86) PCT No.: PCT/CN2022/127908

§ 371 Date: Mar. 14, 2025

(51) Int. Cl. H04W 72/40; H04W 72/0446; H04W 74/0808

(52) U.S. Cl. CPC H04W 72/40; H04W 72/0446; H04W 74/0808

(57) ABSTRACT

Methods, systems, and devices for wireless communications supporting scheduling and resource reservation for multi-slot transmissions are described. A first user equipment (UE) may transmit a sidelink control information (SCI) message to one or more other UEs. The SCI message may reserve sidelink resources across multiple slots. Then, the UE may perform a listen-before-talk (LBT) procedure before the multiple slots. In some examples, the LBT procedure may indicate that the reserved sidelink resources are available, and the UE may transmit sidelink data to one or more other UEs via the multiple slots. The sidelink data (e.g., cyclic prefix (CP) associated with the sidelink data) transmitted via the multiple slots may occupy one or more of a gap symbol of the multiple slots, or an automatic gain control (AGC) symbol of the multiple slots.

### CROSS REFERENCE

This application is a 371 National Stage of PCT Application No. PCT/CN2022/127908, filed on Oct. 27, 2022, entitled “SCHEDULING AND RESOURCE RESERVATION FOR MULTI-SLOT TRANSMISSIONS”, and assigned to the assignee hereof. The disclosure of the prior Application is considered part of and is incorporated by reference into this Patent Application.

### FIELD OF TECHNOLOGY

The following relates to wireless communications, including scheduling and resource reservation for multi-slot transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless communications systems may support sidelink communications between UEs.

### SUMMARY

The described techniques relate to improved methods, systems, devices, and apparatuses that support scheduling and resource reservation for multi-slot transmissions. For example, the described techniques support sidelink transmissions that occupy a gap symbol, an automatic gain control (AGC) symbol, or both. By implementing such techniques, a first user equipment (UE) may maintain use of a shared sidelink channel (e.g., an unlicensed sidelink channel), which may result in the first UE having continued access to the channel between the reserved slots. The first UE may reserve multiple sidelink slots via a sidelink control information (SCI) message (e.g., SCI 1). Prior to the multiple slots, the first UE may perform an LBT procedure. If the LBT procedure is successful, then the first UE may transmit sidelink data to one or more UEs via one or more of the reserved slots to one or more additional sidelink UEs. The first UE may transmit a cyclic prefix (CP) of a transport block (TB) via the AGC symbol of a slot, or may transmit sidelink data via one or both of the AGC symbol and the gap symbol of the slot. Such techniques may result in the first UE being able to maintain access to the channel across multiple slots, and may further result in increased throughput (e.g., via multiple slots, or via the AGC symbol, gap symbol, or both).

The first UE may indicate (e.g., via RRC signaling) that AGC symbols, gap symbols, or both, are to be utilized for multi-slot sidelink transmissions, or may dynamically indicate (e.g., via an SCI 1 message or an SCI 2 message) that an AGC symbol, gap symbol, or both, of a slot is enabled for sidelink transmissions (e.g., of a cycle prefix or data signaling). The first UE may also reserve multiple resources for retransmissions of a multi-slot transmission. In some examples, for retransmission of some (e.g., but not all) TBs, the UE may determine (e.g., according to one or more rules or conditions) whether, or how, to use excess reserved resources for retransmission.

A method is described. The method may include transmitting, by a first user equipment (UE) to at least a second UE, a sidelink control information message reserving sidelink resources across a set of multiple slots, performing a listen-before-talk procedure prior to the set of multiple slots, and transmitting, based on the listen-before-talk procedure indicating that the reserved sidelink resources are available, sidelink data to at least the second UE via the set of multiple slots, where the sidelink data, or a cyclic prefix associated with the sidelink data, or both, occupy at least one of a gap symbol of the set of multiple slots, or an automatic gain control symbol of the set of multiple slots.

An apparatus is described. The apparatus may include a processor, memory coupled with the processor, and instructions stored in the memory. The instructions may be executable by the processor to cause the apparatus to transmit, by a first UE to at least a second UE, a sidelink control information message reserving sidelink resources across a set of multiple slots, perform a listen-before-talk procedure prior to the set of multiple slots, and transmit, based on the listen-before-talk procedure indicating that the reserved sidelink resources are available, sidelink data to at least the second UE via the set of multiple slots, where the sidelink data, or a cyclic prefix associated with the sidelink data, or both, occupy at least one of a gap symbol of the set of multiple slots, or an automatic gain control symbol of the set of multiple slots.

Another apparatus is described. The apparatus may include means for transmitting, by a first UE to at least a second UE, a sidelink control information message reserving sidelink resources across a set of multiple slots, means for performing a listen-before-talk procedure prior to the set of multiple slots, and means for transmitting, based on the listen-before-talk procedure indicating that the reserved sidelink resources are available, sidelink data to at least the second UE via the set of multiple slots, where the sidelink data, or a cyclic prefix associated with the sidelink data, or both, occupy at least one of a gap symbol of the set of multiple slots, or an automatic gain control symbol of the set of multiple slots.

A non-transitory computer-readable medium storing code is described. The code may include instructions executable by a processor to transmit, by a first UE to at least a second UE, a sidelink control information message reserving sidelink resources across a set of multiple slots, perform a listen-before-talk procedure prior to the set of multiple slots, and transmit, based on the listen-before-talk procedure indicating that the reserved sidelink resources are available, sidelink data to at least the second UE via the set of multiple slots, where the sidelink data, or a cyclic prefix associated with the sidelink data, or both, occupy at least one of a gap symbol of the set of multiple slots, or an automatic gain control symbol of the set of multiple slots.

In some examples of the method, apparatuses, and non-transitory computer-readable medium described herein, transmitting the sidelink data may include operations, features, means, or instructions for transmitting the sidelink data to the second UE during a first slot of the set of multiple slots, where the cyclic prefix occupies the gap symbol of the first slot.

In some examples of the method, apparatuses, and non-transitory computer-readable medium described herein, transmitting the sidelink data may include operations, features, means, or instructions for transmitting a first transport block of the sidelink data to the second UE during a first slot of the set of multiple slots, where the first transport block of the sidelink data occupies a first automatic gain control symbol of the first slot and a first gap symbol of the first slot and transmitting a second transport block of the sidelink data to the second UE during a second slot of the set of multiple slots, where the second transport block of the sidelink data occupies a second automatic gain control symbol of the second slot and a second gap symbol of the second slot.

In some examples of the method, apparatuses, and non-transitory computer-readable medium described herein, transmitting the sidelink data may include operations, features, means, or instructions for transmitting a first transport block of the sidelink data to the second UE during a first slot of the set of multiple slots, where the first transport block of the sidelink data occupies a first gap symbol of the first slot and transmitting a second transport block of the sidelink data to a third UE during a second slot of the set of multiple slots, where the second transport block of the sidelink data occupies a second gap symbol of the second slot.

In some examples of the method, apparatuses, and non-transitory computer-readable medium described herein, transmitting the sidelink data may include operations, features, means, or instructions for transmitting a first transport block of the sidelink data to the second UE during a first slot of the set of multiple slots, where the first transport block of the sidelink data occupies a first gap symbol of the first slot and a first automatic gain control symbol of the first slot and transmitting a second transport block of the sidelink data to a third UE during a second slot of the set of multiple slots, where the second transport block of the sidelink data occupies a second gap symbol of the second slot and a second automatic gain control symbol of the second slot.

Some examples of the method, apparatuses, and non-transitory computer-readable medium described herein may further include operations, features, means, or instructions for transmitting, to at least the second UE, control signaling enabling sidelink data transmissions via the automatic gain control symbol, the gap symbol, or both for multi-slot transmissions, where transmitting the sidelink data to at least the second UE via the set of multiple slots may be based on receiving the control signaling.

Some examples of the method, apparatuses, and non-transitory computer-readable medium described herein may further include operations, features, means, or instructions for transmitting, via a second slot of the set of multiple slots, a second sidelink control information message enabling sidelink data transmissions via the automatic gain control symbol, the gap symbol, or both for a multi-slot transmission associated with the set of multiple slots, where transmitting the sidelink data to at least the second UE via the set of multiple slots may be based on receiving the second sidelink control information message.

In some examples of the method, apparatuses, and non-transitory computer-readable medium described herein, a first bit in the second sidelink control information message corresponds to the automatic gain control symbol, and a second bit in the second sidelink control information message corresponds to the gap symbol.

Some examples of the method, apparatuses, and non-transitory computer-readable medium described herein may further include operations, features, means, or instructions for transmitting, via a second slot of the set of multiple slots, a second sidelink control information message indicating a first modulation and coding scheme associated with a first transport block of the sidelink data.

In some examples of the method, apparatuses, and non-transitory computer-readable medium described herein, transmitting the sidelink data may include operations, features, means, or instructions for transmitting the first transport block to the second UE via the second slot according to the first modulation and coding scheme and transmitting a second transport block to a third UE via a third slot of the set of multiple slots according to a second modulation and coding scheme that may be based on the first modulation and coding scheme, a first quantity of resource elements associated with the first transport block, and a second quantity of resource elements associated with the second transport block.

In some examples of the method, apparatuses, and non-transitory computer-readable medium described herein, transmitting the sidelink data may include operations, features, means, or instructions for transmitting a first transport block to the second UE via a second slot of the set of multiple slots according to a first modulation and coding scheme and transmitting the first transport block to a third UE via the second slot according to a second modulation and coding scheme.

Some examples of the method, apparatuses, and non-transitory computer-readable medium described herein may further include operations, features, means, or instructions for receiving control signaling configuring a sidelink resource pool including the sidelink resources, the sidelink resource pool corresponding to a quantity of consecutive slots equal to a quantity of slots of the set of multiple slots, where transmitting the sidelink data via the set of multiple slots may be based on the sidelink resource pool.

Some examples of the method, apparatuses, and non-transitory computer-readable medium described herein may further include operations, features, means, or instructions for transmitting, via a second slot of the set of multiple slots, an additional sidelink control information message reserving a second set of multiple slots for retransmission of the sidelink data, receiving, based on transmitting the sidelink data, feedback signaling indicating failed reception of a first transport block of the sidelink data and successful reception of a second transport block of the sidelink data, and retransmitting the first transport block via a first slot of the second set of multiple slots based on the feedback signaling.

Some examples of the method, apparatuses, and non-transitory computer-readable medium described herein may further include operations, features, means, or instructions for discarding, for sidelink signaling, a second slot of the second set of multiple slots based on the feedback signaling.

Some examples of the method, apparatuses, and non-transitory computer-readable medium described herein may further include operations, features, means, or instructions for transmitting a repetition of the first transport block via a second slot of the second set of multiple slots based on the feedback signaling.

Some examples of the method, apparatuses, and non-transitory computer-readable medium described herein may further include operations, features, means, or instructions for transmitting a third transport block via a second slot of the second set of multiple slots based on the feedback signaling.

A method for wireless communications is described. The method may include receiving, from a first UE by at least a second UE, a sidelink control information message reserving sidelink resources across a set of multiple slots and receiving, based on the sidelink control information message, sidelink data via one or more of the set of multiple slots, where the sidelink data, or a cyclic prefix associated with the sidelink data, or both, occupy at least one of a gap symbol of the set of multiple slots, or an automatic gain control symbol of the set of multiple slots.

An apparatus for wireless communications is described. The apparatus may include a processor, memory coupled with the processor, and instructions stored in the memory. The instructions may be executable by the processor to cause the apparatus to receive, from a first UE by at least a second UE, a sidelink control information message reserving sidelink resources across a set of multiple slots and receive, based on the sidelink control information message, sidelink data via one or more of the set of multiple slots, where the sidelink data, or a cyclic prefix associated with the sidelink data, or both, occupy at least one of a gap symbol of the set of multiple slots, or an automatic gain control symbol of the set of multiple slots.

Another apparatus for wireless communications is described. The apparatus may include means for receiving, from a first UE by at least a second UE, a sidelink control information message reserving sidelink resources across a set of multiple slots and means for receiving, based on the sidelink control information message, sidelink data via one or more of the set of multiple slots, where the sidelink data, or a cyclic prefix associated with the sidelink data, or both, occupy at least one of a gap symbol of the set of multiple slots, or an automatic gain control symbol of the set of multiple slots.

A non-transitory computer-readable medium storing code for wireless communications is described. The code may include instructions executable by a processor to receive, from a first UE by at least a second UE, a sidelink control information message reserving sidelink resources across a set of multiple slots and receive, based on the sidelink control information message, sidelink data via one or more of the set of multiple slots, where the sidelink data, or a cyclic prefix associated with the sidelink data, or both, occupy at least one of a gap symbol of the set of multiple slots, or an automatic gain control symbol of the set of multiple slots.

In some examples of the method, apparatuses, and non-transitory computer-readable medium described herein, receiving the sidelink data may include operations, features, means, or instructions for receiving the sidelink data during a first slot of the set of multiple slots, where the cyclic prefix occupies the gap symbol of the first slot.

In some examples of the method, apparatuses, and non-transitory computer-readable medium described herein, receiving the sidelink data may include operations, features, means, or instructions for receiving a first transport block of the sidelink data during a first slot of the set of multiple slots, where the first transport block of the sidelink data occupies a first automatic gain control symbol of the first slot and a first gap symbol of the first slot and receiving a second transport block of the sidelink data during a second slot of the set of multiple slots, where the second transport block of the sidelink data occupies a second automatic gain control symbol of the second slot and a second gap symbol of the second slot.

In some examples of the method, apparatuses, and non-transitory computer-readable medium described herein, receiving the sidelink data may include operations, features, means, or instructions for receiving a first transport block of the sidelink data during a first slot of the set of multiple slots, where the first transport block of the sidelink data occupies the gap symbol of the first slot.

Some examples of the method, apparatuses, and non-transitory computer-readable medium described herein may further include operations, features, means, or instructions for receiving control signaling enabling sidelink data transmissions via the automatic gain control symbol, the gap symbol, or both for multi-slot transmissions, where receiving the sidelink data may be based on receiving the control signaling.

Some examples of the method, apparatuses, and non-transitory computer-readable medium described herein may further include operations, features, means, or instructions for receiving, via a second slot of the set of multiple slots, a second sidelink control information message enabling sidelink data transmissions via the automatic gain control symbol, the gap symbol, or both for a multi-slot transmission associated with the set of multiple slots, where receiving the sidelink data may be based on receiving the second sidelink control information message.

In some examples of the method, apparatuses, and non-transitory computer-readable medium described herein, a first bit in the second sidelink control information message corresponds to the automatic gain control symbol, and a second bit in the second sidelink control information message corresponds to the gap symbol.

Some examples of the method, apparatuses, and non-transitory computer-readable medium described herein may further include operations, features, means, or instructions for receiving, via a second slot of the set of multiple slots, a second sidelink control information message indicating a first modulation and coding scheme associated with a first transport block of the sidelink data and receiving the first transport block via the second slot according to the first modulation and coding scheme.

Some examples of the method, apparatuses, and non-transitory computer-readable medium described herein may further include operations, features, means, or instructions for receiving control signaling configuring a sidelink resource pool including the sidelink resources, the sidelink resource pool corresponding to a quantity of consecutive slots equal to a quantity of slots of the set of multiple slots, where receiving the sidelink data via the set of multiple slots may be based on the sidelink resource pool.

Some examples of the method, apparatuses, and non-transitory computer-readable medium described herein may further include operations, features, means, or instructions for receiving, via a second slot of the set of multiple slots, an additional sidelink control information message reserving a second set of multiple slots for retransmission of the sidelink data, transmitting, based on receiving the sidelink data, feedback signaling indicating failed reception of a first transport block and successful reception of a second transport block of the sidelink data, and receiving a retransmission of the first transport block via a first slot of the second set of multiple slots based on the feedback signaling.

Some examples of the method, apparatuses, and non-transitory computer-readable medium described herein may further include operations, features, means, or instructions for refraining from monitoring a second slot of the second set of multiple slots based on the feedback signaling.

Some examples of the method, apparatuses, and non-transitory computer-readable medium described herein may further include operations, features, means, or instructions for receiving a repetition of the first transport block via a second slot of the second set of multiple slots based on the feedback signaling.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports scheduling and resource reservation for multi-slot transmissions in accordance with one or more aspects of the present disclosure.

FIG. 2 illustrates an example of a wireless communications system that supports scheduling and resource reservation for multi-slot transmissions in accordance with one or more aspects of the present disclosure.

FIG. 3 illustrates an example of a transmission timeline that supports scheduling and resource reservation for multi-slot transmissions in accordance with one or more aspects of the present disclosure.

FIG. 4 illustrates an example of a transmission timeline that supports scheduling and resource reservation for multi-slot transmissions in accordance with one or more aspects of the present disclosure.

FIG. 5 illustrates an example of a resource grid that supports scheduling and resource reservation for multi-slot transmissions in accordance with one or more aspects of the present disclosure.

FIG. 6 illustrates an example of a resource grid that supports scheduling and resource reservation for multi-slot transmissions in accordance with one or more aspects of the present disclosure.

FIG. 7 illustrates an example of a flow diagram that supports scheduling and resource reservation for multi-slot transmissions in accordance with one or more aspects of the present disclosure.

FIGS. 8 and 9 illustrate block diagrams of devices that support scheduling and resource reservation for multi-slot transmissions in accordance with one or more aspects of the present disclosure.

FIG. 10 illustrates a block diagram of a communications manager that supports scheduling and resource reservation for multi-slot transmissions in accordance with one or more aspects of the present disclosure.

FIG. 11 illustrates a diagram of a system including a device that supports scheduling and resource reservation for multi-slot transmissions in accordance with one or more aspects of the present disclosure.

FIGS. 12 through 15 illustrate flowcharts showing methods that support scheduling and resource reservation for multi-slot transmissions in accordance with one or more aspects of the present disclosure.

### DETAILED DESCRIPTION

In some sidelink communications scenarios, a first user equipment (UE) may reserve sidelink resources for sidelink transmissions (e.g., to one or more additional sidelink UEs) via a shared sidelink channel. Subsequently, prior to transmitting using the reserved resources, the first UE (e.g., and one or more additional UEs) may perform a listen-before-talk (LBT) procedure to gain access to the channel. If the first UE successfully reserves the resources, the first UE may transmit sidelink signaling using the reserved sidelink resources. If the first UE reserves a limited number of resource (e.g., one slot), the sidelink UEs may experience decreased throughput. In some examples, the UE may reserve multiple slots for sidelink communications. Each of the sidelink slots may include an automatic gain control (AGC) symbol, and a gap symbol, during which the transmitting UE refrains from transmitting sidelink communications. However, if the first UE refrains from transmitting during these empty symbols, or if the UE fails to regain access to the sidelink channel prior to any one of the multiple reserved slots, the first UE may lose access to the channel (e.g., due to another device transmitting during at least one of the gap symbol or the AGC symbol between the slots), and may be unable to transmit sidelink data during the reserved slots.

The described techniques support sidelink transmissions that occupy a gap symbol, an AGC symbol, or both. By implementing such techniques, a first UE may maintain use of a shared sidelink channel (e.g., an unlicensed sidelink channel), which may result in the first UE having continued access to the channel between the reserved slots. The first UE may reserve multiple sidelink slots via a sidelink control information (SCI) message (e.g., SCI 1). Prior to the multiple slots, the first UE may perform an LBT procedure. If the LBT procedure is successful, then the first UE may transmit sidelink data to one or more UEs via one or more of the reserved slots to one or more additional sidelink UEs. The first UE may transmit a cyclic prefix (CP) of a transport block (TB) via the AGC symbol of a slot, or may transmit sidelink data via one or both of the AGC symbol and the gap symbol of the slot. Such techniques may result in the first UE being able to maintain access to the channel across multiple slots, and may further result in increased throughput (e.g., via multiple slots, or via the AGC symbol, gap symbol, or both).

The first UE may indicate (e.g., via RRC signaling) that AGC symbols, gap symbols, or both, are to be utilized for multi-slot sidelink transmissions, or may dynamically indicate (e.g., via an SCI 1 message or an SCI 2 message) that an AGC symbol, gap symbol, or both, of a slot is enabled for sidelink transmissions (e.g., of a cycle prefix or data signaling). The first UE may also reserve multiple resources for retransmissions of a multi-slot transmission. In some examples, for retransmission of some (e.g., but not all) TBs, the UE may determine (e.g., according to one or more rules or conditions) whether, or how, to use excess reserved resources for retransmission.

Aspects of the disclosure are initially described in the context of wireless communications systems. Aspects of the disclosure are further illustrated by and described with reference to a wireless communications system, transmission timelines, resource grids, and flow diagram. Aspects of the disclosure are further illustrated by and described with reference to apparatus diagrams, system diagrams, and flowcharts that relate to scheduling and resource reservation for multi-slot transmissions.

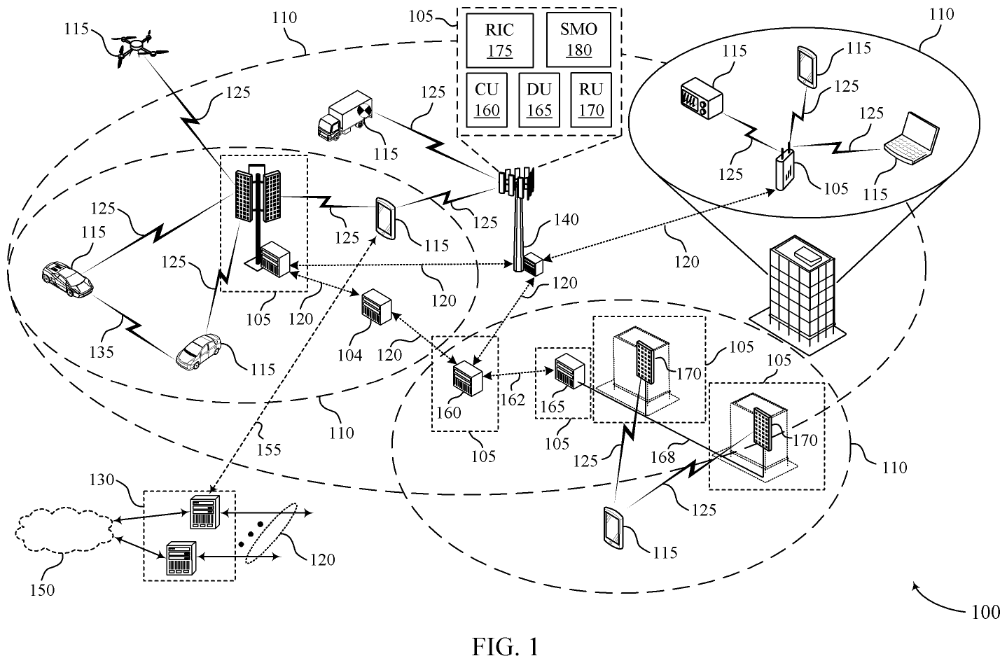

FIG. 1 illustrates an example of a wireless communications system 100 that supports scheduling and resource reservation for multi-slot transmissions in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support scheduling and resource reservation for multi-slot transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a CP. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the CP prepended to each symbol period). In some wireless communications systems 100, a slot may further be divided into multiple mini-slots associated with one or more symbols. Excluding the CP, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The described techniques support sidelink transmissions that occupy a gap symbol, an AGC symbol, or both. By implementing such techniques, a first UE 115 may maintain use of a shared sidelink channel (e.g., an unlicensed sidelink channel), which may result in the first UE 115 having continued access to the channel between the reserved slots. The first UE 115 may reserve multiple sidelink slots via a SCI message (e.g., SCI 1). Prior to the multiple slots, the first UE 115 may perform an LBT procedure. If the LBT procedure is successful, then the first UE 115 may transmit sidelink data to one or more UEs 115 via one or more of the reserved slots to one or more additional sidelink UEs 115. The first UE 115 may transmit a CP of a TB via the AGC symbol of a slot, or may transmit sidelink data via one or both of the AGC symbol and the gap symbol of the slot. Such techniques may result in the first UE 115 being able to maintain access to the channel across multiple slots, and may further result in increased throughput (e.g., via multiple slots, or via the AGC symbol, gap symbol, or both).

The first UE 115 may indicate (e.g., via RRC signaling) that AGC symbols, gap symbols, or both, are to be utilized for multi-slot sidelink transmissions, or may dynamically indicate (e.g., via an SCI 1 message or an SCI 2 message) that an AGC symbol, gap symbol, or both, of a slot is enabled for sidelink transmissions (e.g., of a cycle prefix or data signaling). The first UE 115 may also reserve multiple resources for retransmissions of a multi-slot transmission. In some examples, for retransmission of some (e.g., but not all) TBs, the UE 115 may determine (e.g., according to one or more rules or conditions) whether, or how, to use excess reserved resources for retransmission.

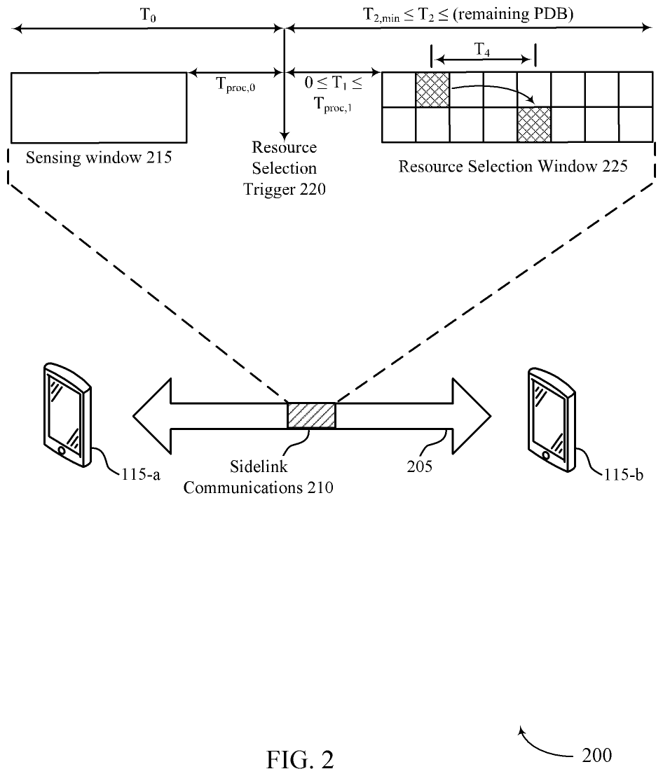

FIG. 2 illustrates an example of a wireless communications system 200 that supports scheduling and resource reservation for multi-slot transmissions in accordance with one or more aspects of the present disclosure. The wireless communications system 200 may illustrate the resource scheduling and reservation through transmissions and communications between a UE 115-a and a UE 115-b. The UE 115-a and the UE 115-b may be examples of the UE 115 as described with reference to FIG. 1. Sidelink communications 210 may be transmitted via a bidirectional communication link 205 (e.g., sidelink communication link, which may be referred to as a PC-5 link) between the UE 115-a and the UE 115-b.

The sidelink communications 210 may include a sensing window 215, a resource selection trigger 220, and a resource selection window 225. The UE 115 (e.g., the UE 115-a, the UE 115-b) may perform sensing in a sensing window 215 to, for example, monitor for SCI from other UEs 115 reserving resource for sidelink communications. For example, the UE 115-a may perform sensing in the sensing window 215 to monitor for SCI from the UE 115-b. The UE 115-a may then process the SCI in a configured processing time T_{proc,0}. The duration of the sensing window 215 and the duration of T_{proc,0} may make up a time T₀. After performing sensing and processing the received SCI, the UE 115-a may be triggered to select resources on which to transmit an inter-UE coordination message (e.g., based on a resource selection trigger 220). The resource selection trigger 220 may be received at a lower layer at the UE 115-a from an upper layer at the UE 115-a. The resource selection window 225 in which to select the resources for transmission may be determined by times T₁ and T₂.

The time T₁ may refer to a time for processing the resource selection and may process as long as (e.g., or less than) a configured processing time T_{proc,1}. The UE 115-a may select sidelink resources in the resource selection window 225 on which to transmit the resource selection. The resource selection window 225 may be after the time T₁. The time T₂ may refer to a time for selecting resources for a transmission with a lower bound of T_{2,min} and an upper bound of a remaining delay budget (e.g., a packet delay budget (PDB)). The lower bound T_{2,min} may refer to a minimum time for selecting resources for a sidelink message. Thus, the candidate resources for the transmission may be selected in a time window [n+T₁, n+T₂], where n is the time at which resource selection is triggered. For example, the resource selection may be triggered at time n, and the physical layer may examine the sensing window 215 to identify a set of candidate resources in the resource selection window 225. The physical layer may report the candidate resources to the MAC layer, and the MAC layer may randomly select a resource for transmission. In some examples, such as HARQ retransmission, the MAC may also randomly select resources for multiple PSSCHs for the same TB.

Given an initial resource selection threshold (e.g., a reference signal received power (RSRP) threshold), the UE 115 may select a set of candidate resources for the transmission. For instance, the UE 115 may select the set of candidate resources to include unreserved resources and resources reserved with SCIs for which a measurement (e.g., RSRP measurement) is below a resource selection threshold. The time T₄ may refer to a time between selected resources, such as a transmission and retransmission. The resources available in the set (e.g., a size of the set of candidate resources) may be at least a configured percentage (e.g., X%) of available resources in the window. The initial resource selection threshold is iteratively relaxed (e.g., increased) until a point when the configured percentage of available resources is selected (e.g., X% of resources are available). From this selected set of candidate resources, the transmission resources may be chosen randomly or based on a predetermined algorithm.

The UE 115-a may reserve multiple slots for sidelink transmissions for the resource selection window 225. As described herein, the UE 115-a may implement techniques for occupying gap symbols or AGC symbols to maintain access to a sidelink channel across multiple reserved slots.

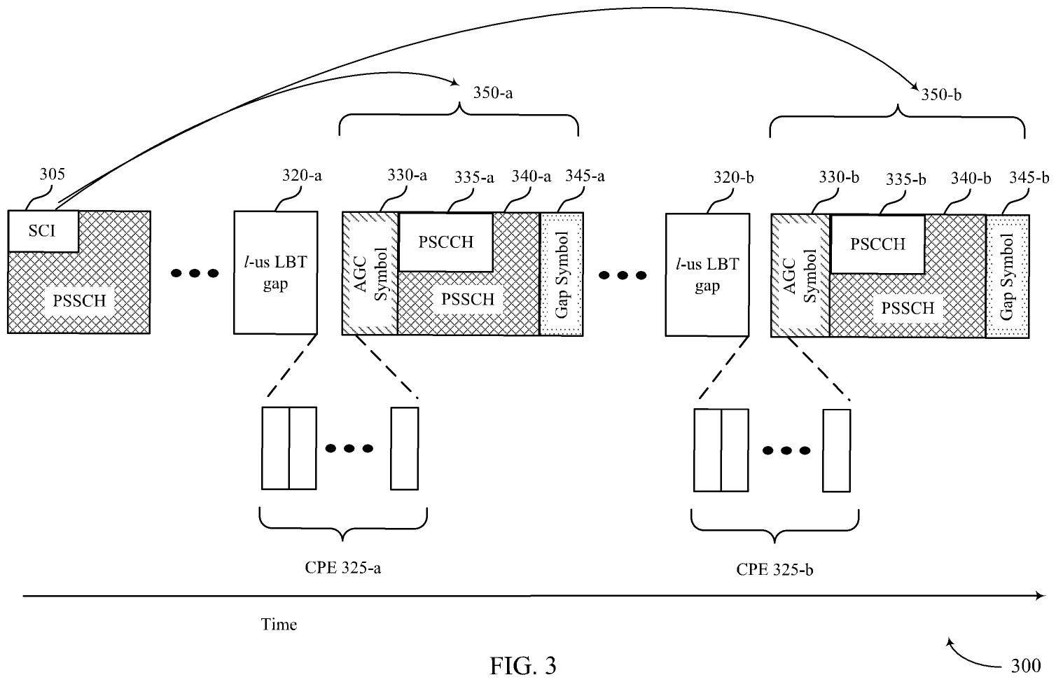

FIG. 3 illustrates an example of a transmission timeline 300 that supports scheduling and resource reservation for multi-slot transmissions in accordance with one or more aspects of the present disclosure. The transmission timeline 300 may illustrate the reservation of resources for multiple slots (e.g., reservation slot 350-a and slot 350-b). For example, one or more UEs 115 may perform sidelink communications according to the transmission timeline 300.

A first UE may transmit an SCI 305 (e.g., an SCI-1 during a slot prior to reserved slots 350-a and reserved slot 350-b). The UE may reserve, via the SCI 305, multiple resources or slots, such as slot 350-a and slot 350-b. Prior to (e.g., or at the beginning of) slot 350-a, there may be an l-us LBT gap 320-a, followed by a CP extension (CPE) 325-a. The slot 350-a may include the AGC symbol 330-a, a PSCCH 335-a, a PSSCH 340-a, and a gap symbol 345-a. Similarly, prior to (e.g., or at the beginning of) slot 350-b, there may be an l-us LBT gap 320-b, followed by a CPE 325-b. The slot 350-b may include the AGC symbol 330-b, a PSCCH 335-b, a PSSCH 340-b, and a gap symbol 345-b. The slot 350-b may be analogous to 350-a, but occur at a different time.

In some examples, the reserved resource in the future slots 350 may be subject to LBT. In some examples, one or two single resources reservations in the upcoming slots (e.g., 32 slots) may not be suitable for sidelink communications (e.g., sidelink on unlicensed bands (SL-U)). For example, the two distributed reserved resources may use two LBTs (e.g., during an LBT gap 320) and the procedure (e.g., Cat4 LBT) may not be clear right before the reserved slot. Thus, resource reservation performed at the granularity of channel occupancy time (COT) may improve the reliability of reserve reservation.

COT based reservation may silence other UEs while the reservation node is performing LBT in the future reserved COT. The UE may directly reserve (e.g., via a codepoint in SCI) a COT, and then perform continuous transmission (e.g., retransmission) therein. The time domain reservation may include a starting time (e.g., a slot) and duration. In some examples, the frequency domain reservation may include the starting subband and the number of contiguous subbands, or RB-set bitmap indicating the reserved subbands (e.g., 20 MHz subbands).

The UE may reserve a starting slot or starting positions (e.g., of a multi-slot transmission) with CPEs (e.g., CPEs 325-a). In some examples, an SCI 305 may indicate that the transmission will start with a CPE (e.g., (m*9+Δ)) ahead of the slot boundary. In some examples, the SCI 305 may indicate the l-us LBT gap 320-a for extended clear channel assessment (eCCA) or LBT before the CPE. After receiving the SCI 305, a sensing or re-evaluation UE with a TB with lower priority may respect the described reservation by occupying the same RB-set with a shorter CPE (e.g., no CPE) ahead of the slot boundary. In some examples, the UE may respect the reservation by puncturing PSSCH in the previous slot, which may maintain silence in the gap for LBT.

In some examples, the gap between two transmissions (e.g., scheduled in slot 350-a and slot 350-b) may exceed a threshold (e.g., 16 us). In such examples, the UE may complete another LBT procedure to contend for access to the channel again. In some examples, the device may lose the channel, such as if LBT fails. For example, if the UE does not perform sidelink communications during one or more AGC symbol 330, or gap symbol 345, the UE may lose access to the unlicensed sidelink channel (e.g., due to a failed LBT, or transmissions by other contenting UEs). Such loss of access to the unlicensed sidelink channel (e.g., between slots of a multi-slot transmission) may result in failed transmission, decreased throughput, increased system latency, and decreased user experience, among other examples. Techniques described herein may support multi-slot transmissions that may maintain the LBT and the channel, scheduling techniques for such multi-slot transmissions, and resource reservation for multi-slot transmissions and retransmissions. For example, CPE 325-a may be included in the AGC symbol 330-a.

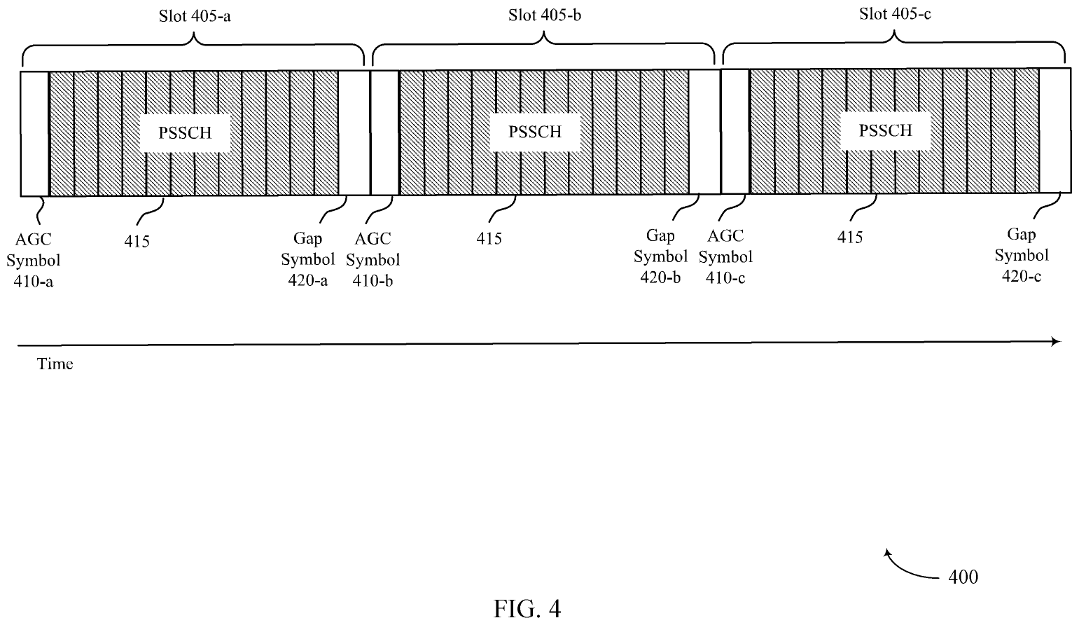

FIG. 4 illustrates an example of a transmission timeline 400 that supports scheduling and resource reservation for multi-slot transmissions in accordance with one or more aspects of the present disclosure. The transmission timeline 400 may illustrate multiple slots over time, and examples of transmissions that may be transmitted in the slots according to techniques described herein.

In some examples (e.g., as described with reference to FIGS. 2-3), a UE may reserve one or more slots 405 (e.g., slot 405-a, slot 405-b, and slot 405-c) for a multi-slot sidelink transmission via an unlicensed channel. Each reservation slot may include an AGC symbol 410, a PSSCH 415, and a gap symbol 420. The reservation slots may contain data, a CP extension, or the first UE may perform AGC. As described herein, to maintain access to the channel and increase throughput, the UE may transmit a CP (e.g., the CP extension) in a gap symbol 420, may transmit data in an AGC symbol 410, may transmit data in a gap symbol 420, or may transmit data in both the AGC symbol 410 and the gap symbol 420. FIG. 4 illustrates various implementations of such techniques.

For example, the UE may transmit a CP extension in the gap symbol 420-a of the slot 405-a. In some examples, the UE may transmit sidelink signaling via the slot 405-a and the slot 405-b consecutively and to the same receiver (e.g., a second UE), and may transmit via the slot 405- to a different receiver (e.g., a third UE). The CP extension may be transmitted in the gap symbol 420-a and the gap symbol 420-b. The CP extension may not be transmitted in the gap symbol 420-c, as the gap symbol 420-c may be the last symbol of the transmission. In some examples, the gap symbol 420-c may be a gap between the last symbol of one slot and a following slot for reception, such as if sidelink data is received via the following slot, in which case the UE may use the gap symbol 420 to implement transmit receive switching (e.g., in case the transmitting UE is to receive sidelink data in a next slot).

In some examples, the first UE may transmit data via the AGC symbol 410, the gap symbol 420, or both. The consecutive slots 405 for transmission may be scheduled for the same receiver or different receivers. Whether the consecutive slots 405 are scheduled for the same or different receivers may affect in which symbols the UE transmits the data.

For example, if the first UE transmits to the same receiver via consecutive slots 405, the UE may transmit the data via the AGC symbol 410, the gap symbol 420 or both. If the first UE transmits to a same receiver via the slot 405-a and the slot 405-b, then the UE may transmit the data via both the AGC symbol 410-b and the gap symbol 420-b. In some examples, the UE may transmit using AGC symbols 410, but may still use a last gap symbol 420 of a last scheduled slot as a gap symbol (e.g., without transmitting any data in the last gap symbol 420).

In some examples, the slots 405 may not be for the same receiver. For example, the slot 405-a and the slot 405-b may be consecutive and associated with the same receiver (e.g., a second UE), while slot 405-c is associated with a different receiver (e.g., a third UE). With reference to FIG. 4, if the slot 405-a and the slot 405-b are associated with the same receiver and the slot 405-c is associated with a different receiver, the first UE may transmit the data via the gap symbol 420-a and the gap symbol 420-b (e.g., but not an AGC symbol 410). The first UE may apply different transmission power for different receivers, and thus utilize AGC symbols 410 different receivers. For instance, for transmission to the second UE, the first UE may perform AGC during the AGC symbol 410-a (e.g., for transmissions to the second UE), may perform AGC during the AGC symbol 410-b, and may perform AGC during the AGC symbol 410-c (e.g., for transmissions to the third UE), but may utilize gap symbols 420-a and 420-b for data transmissions.

In some examples, the first UE may transmit data via both the gap symbols 420 and the AGC symbols 410 (e.g., even for consecutive slots 405 associated with different receivers). For example, if the slot 405-a and the slot 405-b are associated with the same receiver and the slot 405-c is associated with a different receiver, both the gap symbol 420-a, gap symbol 420-b, and the AGC symbol 410-b and the AGC symbol 410-c may be occupied by data transmissions.

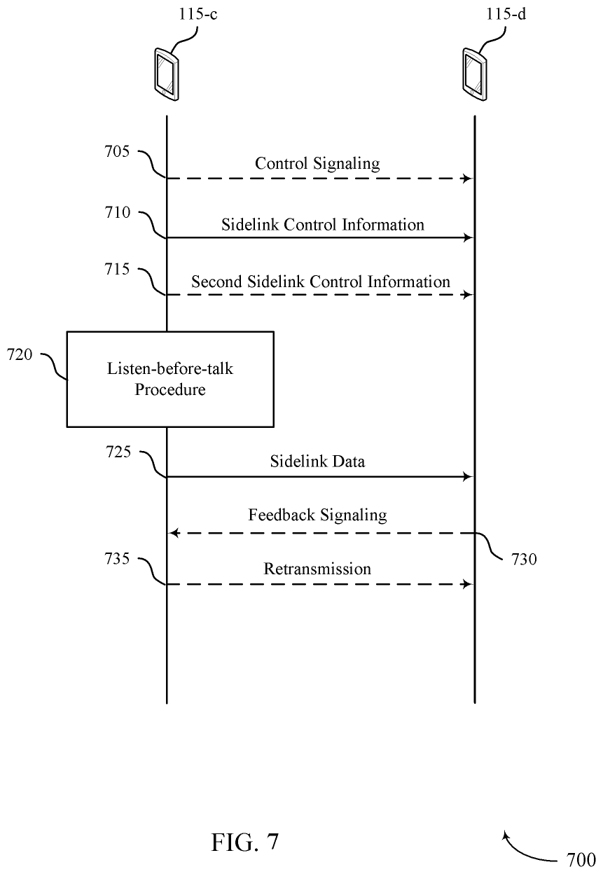

As described in greater detail with reference to FIG. 7, the multi-slot transmissions may be scheduled such that the gap symbols 420, the AGC symbols 410, or both, may be utilized to maintain access to the unlicensed channel. In some examples, RRC signaling may enable the use of gap symbols 420, AGC symbols 410, or both for subsequent multi-slot sidelink transmissions. In some examples, use of gap symbols 420, AGC symbols 410, or both, may be dynamically enabled via SCI signaling (e.g., via SCI-2).

For example, the first UE may receive control signaling (e.g., RRC signaling) configuring whether the gap symbols 420 and the AGC symbols 410 can be used (e.g., are enabled or activated) for data transmission. If the first UE schedules a multi-slot transmission, then based on the RRC signaling, gap symbols 420 and AGC symbols 410 may be used for data transmissions (e.g., unless otherwise indicated via subsequent RRC signaling disabling the use of gap symbols 420 and AGC symbols 410, or turning such behaviors off).

In some examples, the first UE may indicate via an SCI message (e.g., SCI-2) an indication of whether gap symbols 420, AGC symbols 410, or both, can be used (e.g., are activated or enabled) for data transmission. For example, two bits may be included in an SCI-2 message. A first bit may be associated with gap symbols 420 and a second bit may be associated with AGC symbols 410. If a value of one of the two bits is set to one, then the corresponding symbol type may be used for data transmission.

In some examples, the first UE may perform rate matching for various TBs in a multi-slot transmission. For example, an MCS (e.g., indicated in an SCI message) may indicate an actual MCS of a first TB of a set of TBs associated with the multi-slot transmission, and other TBs may be dynamically adjusted from the indicated MCS, based on a quantity of available resource elements (REs). For instance, SCI-1 or SCI-2 may indicate an initial MCS for a first TB (e.g., TB 1), and the first UE may determine (e.g., calculate) a second MCS for a second TB (e.g., TB 2) based on a number of available REs for the second TB (e.g., in a first slot 405) and a number of available REs for the first TB (e.g., in a first slot 405), and the initial MCS (e.g., MCS₂=(N_{RE2}/N_{RE1})·MCS₁). In some examples, separate MCS values for separate receivers of a single TB (e.g., TB 1) may be defined. If there are multiple TBs for transmission to a single receiver, then the MCS of the additional TBs may be deduced (e.g., calculated) from the indicated MCS for the first TB, as described herein.

In some examples, a sidelink UE, or a network entity, may configure resource pools to be associated with different numbers of slots for multi-slot transmissions. For example, the first UE may receive control signaling (e.g., from a network entity or a sidelink UE) configuring one or more sidelink resource pools (e.g., from which the first UE may reserve sidelink resources on an unlicensed sidelink channel). Different resource pools may support different numbers of consecutive slot transmissions. Thus, the first UE may determine a number of consecutive slots reserved for each transmission based on the resource pool to which the consecutive slots correspond.

In some examples, the first UE may reserve multiple sets of resources (e.g., multiple sets of consecutive slots 405) for multi-slot transmissions.

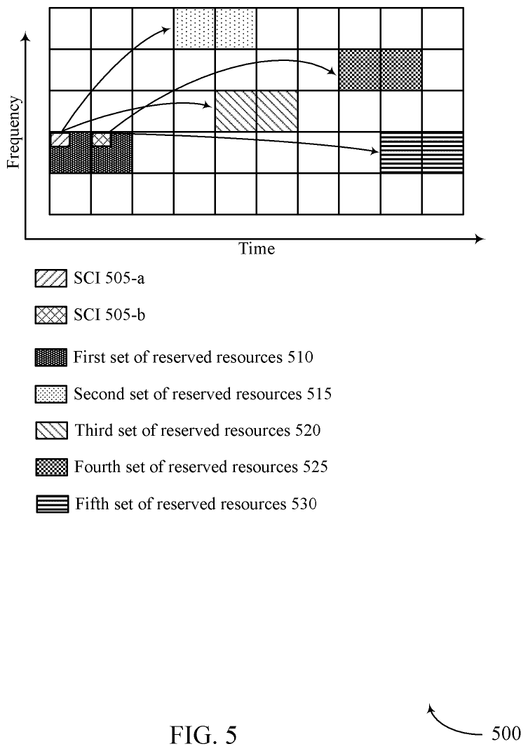

FIG. 5 illustrates an example of a resource grid 500 that supports scheduling and resource reservation for multi-slot transmissions in accordance with one or more aspects of the present disclosure. The resource grid 500 illustrates an example of reserving resources using SCI 505. SCI 505-a and SCI 505-b may be example of SCI-1. In some examples, SCI may be transmitted in each slot, and each slot may reserve up to two future resources. For example, each of SCI 505-a and SCI 505-b may reserve a set of resources. Each set of reserved resources may include multiple resources (e.g., two). A first set of resources, or a second resource of a pair of resources, may be allocated for retransmission. In some examples, the LBT may fail for the retransmission. The resource grid 500 includes the SCI 505-a, the SCI 505-b, a first set of reserved resources 510, a second set of reserved resources 515, a third set of reserved resources 520, a fourth set of reserved resources 525, and a fifth set of reserved resources 530.

The SCI 505-a may reserve multiple (e.g., up to two) future resources (e.g., the second set of reserved resources 515 and the third set of reserved resources 520. Similarly, the SCI 505-b may reserve multiple (e.g., up to two) future resources (e.g., the fourth set of reserved resources 525 and the fifth set of reserved resources 530). Each SCI 505 may reserve up to two future sets of reserved resources. The threshold (e.g., maximum) number of reserved slots (e.g., the number of slots reserved per set of resources) may be the total slots of current multi-slot transmission multiplied by a value. The value (e.g., 2, or 3) may be indicated via control signaling (e.g., via a parameter such as sl_MaxNumPerReserve).

In some examples, the reservation of resources may increase transmission opportunity, such as by mitigating LBT uncertainty, but may increase resource consumption. In some examples, the transmitter may perform an LBT at the resource where the earlier resource has been reserved. If the LBT passes, then another user may use the remaining resource(s) that were reserved for retransmission, which may reduce resource consumption. For instance, the first UE (e.g., the transmitter) may reserve the first set of reserved resources 510 and the second set of reserved resources 515 via the SCI 505-a. The first UE may perform an LBT prior to the first set of resources 510, which may pass. If such is the case, then the first UE may no longer have a transmission to transmit using the second set of reserved resources 515 (e.g., the first UE may no longer have a need for the second set of resources 515). Another UE may perform an LBT prior to the second set of reserved resources 515, and may utilize them for sidelink signaling (e.g., of the first UE may indicate to other UEs that the second set of reserved resources 515 are available).

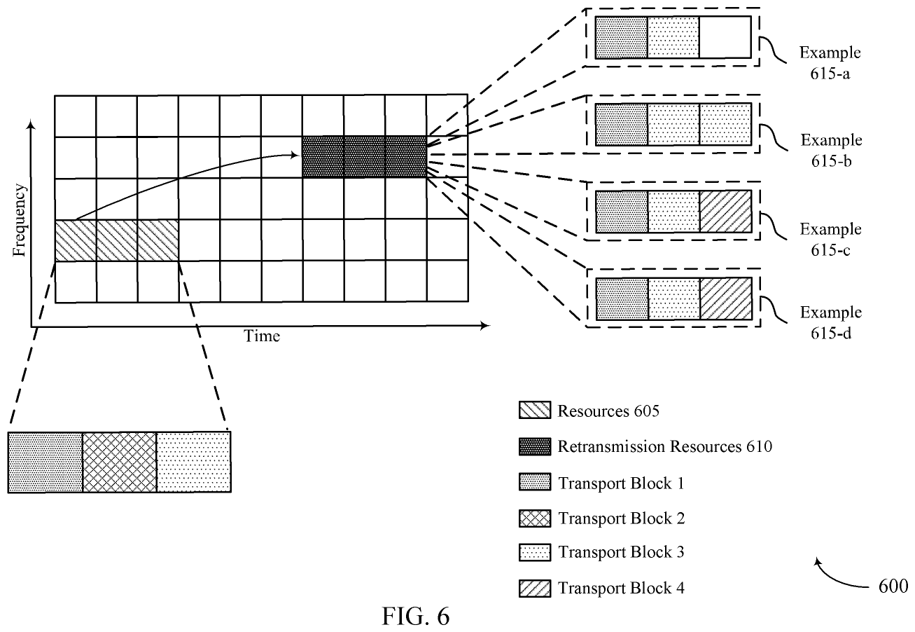

FIG. 6 illustrates an example of a resource grid 600 that supports scheduling and resource reservation for multi-slot transmissions in accordance with one or more aspects of the present disclosure. The resource grid 600 illustrates the use of reserved resources 605 for transmission of TBs, and retransmissions resources 610 for retransmissions of one or more TBs.

A first UE may transmit multiple TBs (e.g., TB 1, TB 2, and TB 3) via resources 605. In some examples, one or more of the TBs transmitted via the resources 605 (e.g., during a multi-slot transmission) may be successfully received, and one or more of the TBs may not be successfully received. The first UE may use the reserved retransmission resources 610 differently, based on which TBs were successfully received and which were not. For instance, if TB2 is successfully decoded by one or more receivers, then the first UE may prepare to retransmit TB1 and TB3. However, the retransmission resources 610 may be sufficient for transmission of three TBs (e.g., instead of two). For example, the first UE may first use the retransmission resources 610 to retransmit the unsuccessful TBs (e.g., TB 1, TB 3). The remaining retransmission resources 610 may be discarded, used to repeat one of the unsuccessful TBs with lower successful decoding probability (e.g., TB 3), or transmit another TB (e.g., TB 4).

For example, TB 2 may be successfully received, and TB 1 and TB 3 may be retransmitted. In example 615-a, the first two slots may be used for retransmitting the TB 1 and the TB 3, and the third slot and remaining resource may be discarded (e.g., the first UE may not utilize the third slot of the retransmission resources 610 for any transmissions).

In example 615-b, the first two slots may be used for retransmitting the TB 1 and the TB 3, respectively, and the remaining retransmission resource 610 may be used to repeat transmission of the TB with the lowest successful decoding probability (e.g., TB 3). To alert the receiver to the repetition of the TB 3, an SCI-2 dynamic indication may indicate a HARQ identifier (ID) for each TB. The HARQ ID for the second transmission and the third transmission may be the same, indicating the repetition of TB 3. In some examples, a bitmap may be indicated via SCI-2, indicating whether the current TB is a repetition of the previous TB (e.g., the bit ‘1’ corresponds to a repetition of the previous TB, so the bitmap would be 001 for example 615-b).

In example 615-c, the first UE may transmit another TB, such as TB 4 (e.g., a new TB), via the available extra slot. The TB 4 may be transmitted to intended receivers of the TB 1, TB 2, or TB 3 (e.g., the additional transport block may only be transmitted to receivers of the previous transport blocks). In example 615-d, the first UE may transmit TB 4 via the remaining slot transmit to any receiver (e.g., whether that receiver corresponds to TB1, TB2, or TB3, or not).

FIG. 7 illustrates an example of a flow diagram 700 that supports scheduling and resource reservation for multi-slot transmissions in accordance with one or more aspects of the present disclosure. Flow diagram 700 illustrates the communications between a UE 115-c and a UE 115-d, which may be examples of the UE 115 as described with reference to FIG. 1. In some examples, the UE 115-c may transmit sidelink signaling to other UEs 115.

At 705, the UE 115-c, which may be referred to as a first UE, may transmit control signaling to the UE 115-d, which may be referred to as a second UE. The control signaling may enable sidelink data transmissions via the AGC symbol, the gap symbol, or both for multi-slot transmissions, where transmitting the sidelink data to at least the second UE (e.g., the UE 115-d) via the multiple slots is based on receiving the control signaling.

In some examples, the control signaling may configuring a sidelink resource pool including the sidelink resources, the sidelink resource pool corresponding to a quantity of consecutive slots equal to a quantity of slots of the multiple slots, where transmitting the sidelink data via the multiple slots is based on the sidelink resource pool.

At 710, the UE 115-c may transmit an SCI message reserving sidelink resources across multiple slots. The UE 115-c may schedule the AGC and gap symbol for data transmission, and may indicate the enabling of the AGC gap symbol, the gap symbol, or both, in a variety of ways. The data transmission may be indicated by RRC configuration or SCI 2. For example, RRC configuration may configure whether the gap symbol, AGS symbols, or both, may be used for data transmission or may not be used for data transmission. In some examples, if the transmitter schedules multi-slot transmission, then the gap symbol, AGC symbol, or both, are used for data transmission.

In examples of rate matching, TBs may be transmitted according to the same modulation and coding scheme (MCS), or different MCSs. Additionally, the MCS may indicate the MCS of the first TB, and the other TBs may dynamically adjust the MCS from the indicated MCSs based on the available resource element. For example, a first MCS for the first TB may be indicated by SCI, and the MCS for a second TB may be indicated by the ratio of available resources (e.g., NRE1/NRE2*MCS, where there is a resource element (RE) for the first TB and the second TB, respectively). In some other examples, separate MCS for separate receivers of the first TB. If there are multiple TBs for one receiver, the MCS for the remaining TBs may be determined from the indicates MCS for the first TB.

At 715, the UE 115-c may transmit a second SCI. The second SCI message (e.g., SCI 2, additional SCI message) may enable sidelink data transmissions via the AGC symbol, the gap symbol, or both, for a multi-slot transmission associated with the multiple slots, where transmitting the sidelink data to at least the second UE (e.g., the UE 115-d) via the multiple slots is based on receiving the second SCI message (e.g., a second message of a second slot). The second SCI message may correspond to the AGC symbol, and a second bit in the second SCI message corresponds to the gap symbol.

In some examples, the SCI (e.g., SCI 2) may dynamically indicate whether the gap symbol and AGC symbols may be used for data transmission. For example, two bits may be included in the SCI 2, where one bit indicates whether the gap symbol is used for data transmission (e.g., a value of the bit of ‘1’), and the other bit may indicate whether the AGC symbol may be used for data transmission.

The UE 115-d may transmit, via a second slot of the multiple slots, a second SCI message (e.g., an additional SCI message, such as SCI-1 or SCI-2) indicating a first MCS associated with a first TB of the sidelink data.

At 720, the UE 115-c may perform a LBT procedure prior to the multiple slots.

At 725, the UE 115-c may transmit sidelink data via the multiple slots. The sidelink data may be based on the LBT procedure indicating that the reserved sidelink resources are available. The sidelink data, a CP associated with the sidelink data, or both, may occupy at least one of a gap symbol of the multiple slots, or an AGC symbol of the multiple slots.

In some examples, the sidelink data may be transmitted during a first slot of the multiple slots, and the CP occupies the gap symbol of the first slot. Transmitting the sidelink data may include transmitting a first TB of the sidelink data to the second UE (e.g., the UE 115-d) during a first slot of the multiple slots, where the first TB of the sidelink data occupies a first AGC symbol of the first slot and a first gap symbol of the first slot, and transmitting a second TB of the sidelink data to the second UE during a second slot of the multiple slots, where the second TB of the sidelink data occupies a second AGC of the second slot and a second gap symbol of the second slot.

In some examples, transmitting the sidelink data may include transmitting a first TB of the sidelink data to the second UE (e.g., the UE 115-d) during a first slot of the multiple slots, where the first TB of the sidelink data occupies a first gap symbol of the first slot, and transmitting a second TB of the sidelink data to a third UE during a second slot of the multiple slots, where the second TB of the sidelink data occupies a second gap symbol of the second slot.

In some examples, transmitting the sidelink data may include transmitting a first TB of the sidelink data to the second UE during a first slot of the multiple slots, where the first TB of the sidelink data occupies a first gap symbol of the first slot and a first AGC of the first slot; and transmitting a second TB of the sidelink data to a third UE during a second slot of the multiple slots, where the second TB of the sidelink data occupies a second gap symbol of the second slot and a second AGC symbol of the second slot.

In some examples, transmitting the sidelink data includes transmitting the first TB to the second UE via the second slot according to the first MCS; and transmitting a second TB to a third UE via a third slot of the multiple slots according to a second MCS that is based on the first MCS, a first quantity of resource elements associated with the first TB, and a second quantity of resource elements associated with the second TB.

In some examples, transmitting the sidelink data includes transmitting a first TB to the second UE via a second slot of the multiple slots according to a first MCS; and transmitting the first TB to a third UE via the second slot according to a second MCS.

The UE 115-d may transmit, via a second slot of the multiple slots, an additional SCI message (e.g., a second SCI message, such as SCI-1 or SCI-2 in a second slot) reserving a second set of multiple slots for retransmission of the sidelink data. The UE 115-d may receive, based on transmitting the sidelink data, feedback signaling indicating failed reception of a first TB of the sidelink data and successful reception of a second TB of the sidelink data (e.g., feedback signaling at 730. The UE 115-c may retransmit (e.g., at 735) the first TB via a first slot of the second set of multiple slots based on the feedback signaling. The UE 115-c may discard, for sidelink signaling, a second slot of the second set of multiple of slots based on the feedback signaling. The UE 115-c may transmit a repetition of the first TB via a second slot of the second set of multiple slots based on the feedback signaling. The UE 115-c may transmit a third RB via a second slot of the second set of multiple slots based on the feedback signaling.

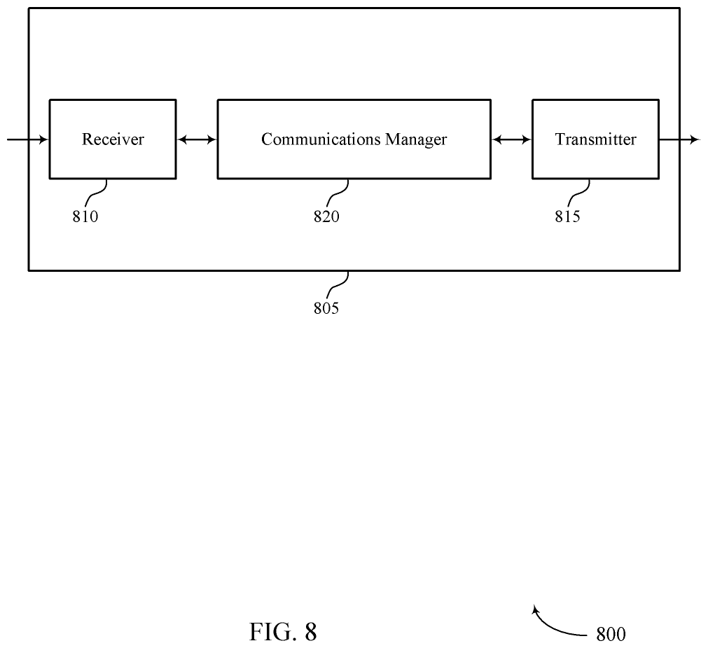

FIG. 8 illustrates a block diagram 800 of a device 805 that supports scheduling and resource reservation for multi-slot transmissions in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to scheduling and resource reservation for multi-slot transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to scheduling and resource reservation for multi-slot transmissions). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of scheduling and resource reservation for multi-slot transmissions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 may be configured as or otherwise support a means for transmitting, by a first UE to at least a second UE, a SCI message reserving sidelink resources across a set of multiple slots. The communications manager 820 may be configured as or otherwise support a means for performing a LBT procedure prior to the set of multiple slots. The communications manager 820 may be configured as or otherwise support a means for transmitting, based on the LBT procedure indicating that the reserved sidelink resources are available, sidelink data to at least the second UE via the set of multiple slots, where the sidelink data, or a CP associated with the sidelink data, or both, occupy at least one of a gap symbol of the set of multiple slots, or an AGC symbol of the set of multiple slots.

Additionally, or alternatively, the communications manager 820 may support wireless communications in accordance with examples as disclosed herein. For example, the communications manager 820 may be configured as or otherwise support a means for receiving, from a first UE by at least a second UE, a SCI message reserving sidelink resources across a set of multiple slots. The communications manager 820 may be configured as or otherwise support a means for receiving, based on the SCI message, sidelink data via one or more of the set of multiple slots, where the sidelink data, or a CP associated with the sidelink data, or both, occupy at least one of a gap symbol of the set of multiple slots, or an AGC symbol of the set of multiple slots.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for scheduling and resource reservation for multi-slot transmissions, which may result in various advantages, such as reduced processing, reduced power consumption, more efficient utilization of communication resources, improve channel utilization efficiency, or improve maintenance of the LBT procedure.

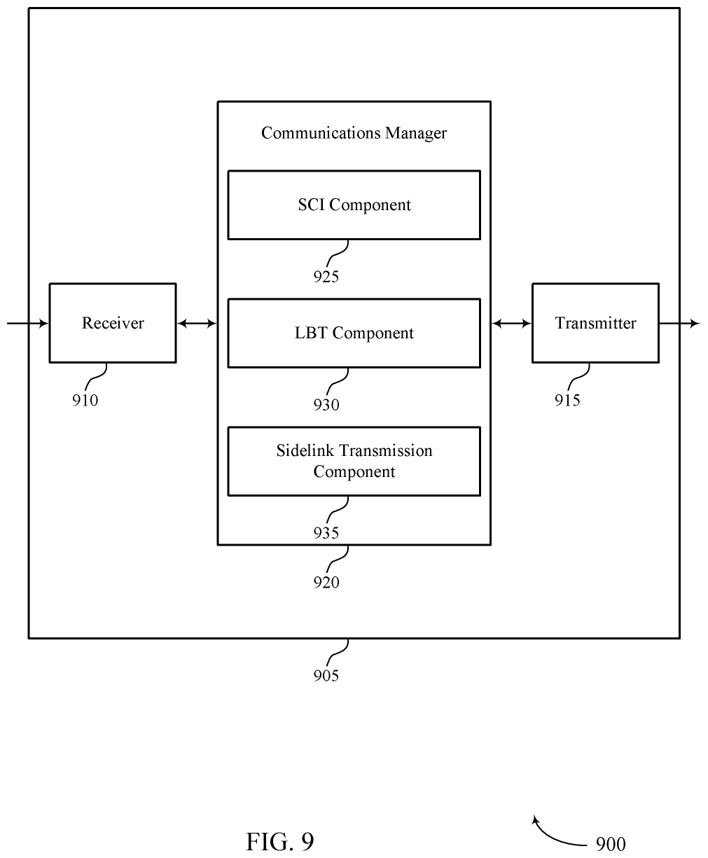

FIG. 9 illustrates a block diagram 900 of a device 905 that supports scheduling and resource reservation for multi-slot transmissions in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to scheduling and resource reservation for multi-slot transmissions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to scheduling and resource reservation for multi-slot transmissions). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of scheduling and resource reservation for multi-slot transmissions as described herein. For example, the communications manager 920 may include an SCI component 925, an LBT component 930, a sidelink transmission component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The SCI component 925 may be configured as or otherwise support a means for transmitting, by a first UE to at least a second UE, a SCI message reserving sidelink resources across a set of multiple slots. The LBT component 930 may be configured as or otherwise support a means for performing a LBT procedure prior to the set of multiple slots. The sidelink transmission component 935 may be configured as or otherwise support a means for transmitting, based on the LBT procedure indicating that the reserved sidelink resources are available, sidelink data to at least the second UE via the set of multiple slots, where the sidelink data, or a CP associated with the sidelink data, or both, occupy at least one of a gap symbol of the set of multiple slots, or an AGC symbol of the set of multiple slots.

Additionally, or alternatively, the communications manager 920 may support wireless communications in accordance with examples as disclosed herein. The SCI component 925 may be configured as or otherwise support a means for receiving, from a first UE by at least a second UE, a SCI message reserving sidelink resources across a set of multiple slots. The sidelink transmission component 935 may be configured as or otherwise support a means for receiving, based on the SCI message, sidelink data via one or more of the set of multiple slots, where the sidelink data, or a CP associated with the sidelink data, or both, occupy at least one of a gap symbol of the set of multiple slots, or an AGC symbol of the set of multiple slots.

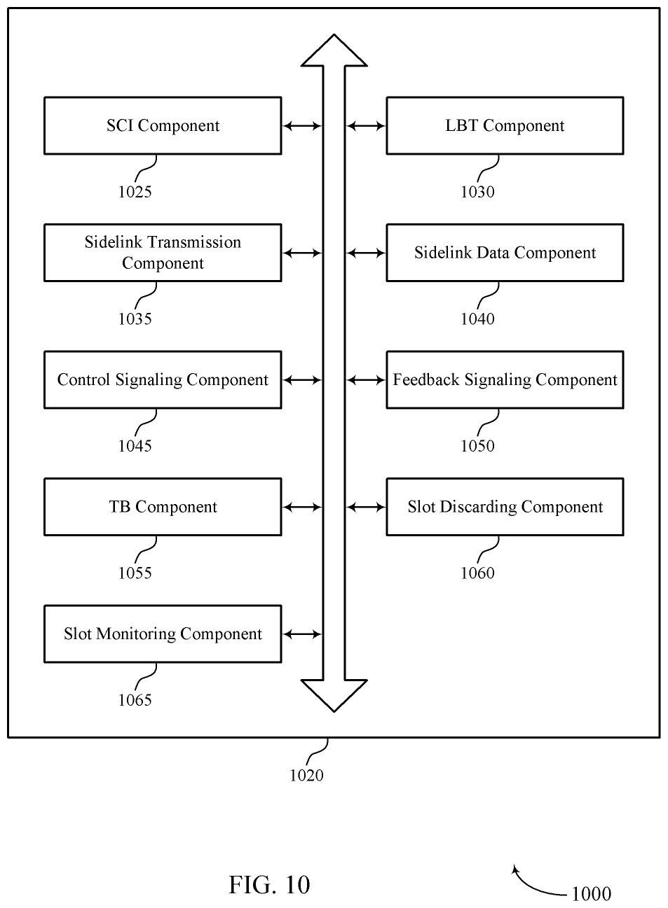

FIG. 10 illustrates a block diagram 1000 of a communications manager 1020 that supports scheduling and resource reservation for multi-slot transmissions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of scheduling and resource reservation for multi-slot transmissions as described herein. For example, the communications manager 1020 may include an SCI component 1025, an LBT component 1030, a sidelink transmission component 1035, a sidelink data component 1040, a control signaling component 1045, a feedback signaling component 1050, a TB component 1055, a slot discarding component 1060, a slot monitoring component 1065, or any combination thereof. Each of these components may communicate, directly or indirectly, with one another (e.g., via one or more buses).

The SCI component 1025 may be configured as or otherwise support a means for transmitting, by a first UE to at least a second UE, a SCI message reserving sidelink resources across a set of multiple slots. The LBT component 1030 may be configured as or otherwise support a means for performing a LBT procedure prior to the set of multiple slots. The sidelink transmission component 1035 may be configured as or otherwise support a means for transmitting, based on the LBT procedure indicating that the reserved sidelink resources are available, sidelink data to at least the second UE via the set of multiple slots, where the sidelink data, or a CP associated with the sidelink data, or both, occupy at least one of a gap symbol of the set of multiple slots, or an AGC symbol of the set of multiple slots.

In some examples, to support transmitting the sidelink data, the sidelink transmission component 1035 may be configured as or otherwise support a means for transmitting the sidelink data to the second UE during a first slot of the set of multiple slots, where the CP occupies the gap symbol of the first slot.

In some examples, to support transmitting the sidelink data, the sidelink data component 1040 may be configured as or otherwise support a means for transmitting a first TB of the sidelink data to the second UE during a first slot of the set of multiple slots, where the first TB of the sidelink data occupies a first AGC symbol of the first slot and a first gap symbol of the first slot. In some examples, to support transmitting the sidelink data, the sidelink data component 1040 may be configured as or otherwise support a means for transmitting a second TB of the sidelink data to the second UE during a second slot of the set of multiple slots, where the second TB of the sidelink data occupies a second AGC symbol of the second slot and a second gap symbol of the second slot.

In some examples, to support transmitting the sidelink data, the sidelink data component 1040 may be configured as or otherwise support a means for transmitting a first TB of the sidelink data to the second UE during a first slot of the set of multiple slots, where the first TB of the sidelink data occupies a first gap symbol of the first slot. In some examples, to support transmitting the sidelink data, the sidelink data component 1040 may be configured as or otherwise support a means for transmitting a second TB of the sidelink data to a third UE during a second slot of the set of multiple slots, where the second TB of the sidelink data occupies a second gap symbol of the second slot.

In some examples, to support transmitting the sidelink data, the sidelink data component 1040 may be configured as or otherwise support a means for transmitting a first TB of the sidelink data to the second UE during a first slot of the set of multiple slots, where the first TB of the sidelink data occupies a first gap symbol of the first slot and a first AGC symbol of the first slot. In some examples, to support transmitting the sidelink data, the sidelink data component 1040 may be configured as or otherwise support a means for transmitting a second TB of the sidelink data to a third UE during a second slot of the set of multiple slots, where the second TB of the sidelink data occupies a second gap symbol of the second slot and a second AGC symbol of the second slot.

In some examples, the control signaling component 1045 may be configured as or otherwise support a means for transmitting, to at least the second UE, control signaling enabling sidelink data transmissions via the AGC symbol, the gap symbol, or both for multi-slot transmissions, where transmitting the sidelink data to at least the second UE via the set of multiple slots is based on receiving the control signaling.

In some examples, the SCI component 1025 may be configured as or otherwise support a means for transmitting, via a second slot of the set of multiple slots, a second SCI message enabling sidelink data transmissions via the AGC symbol, the gap symbol, or both for a multi-slot transmission associated with the set of multiple slots, where transmitting the sidelink data to at least the second UE via the set of multiple slots is based on receiving the second SCI message.

In some examples, a first bit in the second SCI message corresponds to the AGC symbol, and a second bit in the second SCI message corresponds to the gap symbol.

In some examples, the SCI component 1025 may be configured as or otherwise support a means for transmitting, via a second slot of the set of multiple slots, a second SCI message indicating a first MCS associated with a first TB of the sidelink data.

In some examples, to support transmitting the sidelink data, the sidelink data component 1040 may be configured as or otherwise support a means for transmitting the first TB to the second UE via the second slot according to the first MCS. In some examples, to support transmitting the sidelink data, the sidelink data component 1040 may be configured as or otherwise support a means for transmitting a second TB to a third UE via a third slot of the set of multiple slots according to a second MCS that is based on the first MCS, a first quantity of resource elements associated with the first TB, and a second quantity of resource elements associated with the second TB.

In some examples, to support transmitting the sidelink data, the sidelink data component 1040 may be configured as or otherwise support a means for transmitting a first TB to the second UE via a second slot of the set of multiple slots according to a first MCS. In some examples, to support transmitting the sidelink data, the sidelink data component 1040 may be configured as or otherwise support a means for transmitting the first TB to a third UE via the second slot according to a second MCS.

In some examples, the control signaling component 1045 may be configured as or otherwise support a means for receiving control signaling configuring a sidelink resource pool including the sidelink resources, the sidelink resource pool corresponding to a quantity of consecutive slots equal to a quantity of slots of the set of multiple slots, where transmitting the sidelink data via the set of multiple slots is based on the sidelink resource pool.

In some examples, the SCI component 1025 may be configured as or otherwise support a means for transmitting, via a second slot of the set of multiple slots, an additional SCI message reserving a second set of multiple slots for retransmission of the sidelink data. In some examples, the feedback signaling component 1050 may be configured as or otherwise support a means for receiving, based on transmitting the sidelink data, feedback signaling indicating failed reception of a first TB of the sidelink data and successful reception of a second TB of the sidelink data. In some examples, the TB component 1055 may be configured as or otherwise support a means for retransmitting the first TB via a first slot of the second set of multiple slots based on the feedback signaling.

In some examples, the slot discarding component 1060 may be configured as or otherwise support a means for discarding, for sidelink signaling, a second slot of the second set of multiple slots based on the feedback signaling.

In some examples, the TB component 1055 may be configured as or otherwise support a means for transmitting a repetition of the first TB via a second slot of the second set of multiple slots based on the feedback signaling.

In some examples, the TB component 1055 may be configured as or otherwise support a means for transmitting a third TB via a second slot of the second set of multiple slots based on the feedback signaling.

Additionally, or alternatively, the communications manager 1020 may support wireless communications in accordance with examples as disclosed herein. In some examples, the SCI component 1025 may be configured as or otherwise support a means for receiving, from a first UE by at least a second UE, a SCI message reserving sidelink resources across a set of multiple slots. In some examples, the sidelink transmission component 1035 may be configured as or otherwise support a means for receiving, based on the SCI message, sidelink data via one or more of the set of multiple slots, where the sidelink data, or a CP associated with the sidelink data, or both, occupy at least one of a gap symbol of the set of multiple slots, or an AGC symbol of the set of multiple slots.

In some examples, to support receiving the sidelink data, the sidelink transmission component 1035 may be configured as or otherwise support a means for receiving the sidelink data during a first slot of the set of multiple slots, where the CP occupies the gap symbol of the first slot.

In some examples, to support receiving the sidelink data, the sidelink data component 1040 may be configured as or otherwise support a means for receiving a first TB of the sidelink data during a first slot of the set of multiple slots, where the first TB of the sidelink data occupies a first AGC symbol of the first slot and a first gap symbol of the first slot. In some examples, to support receiving the sidelink data, the sidelink data component 1040 may be configured as or otherwise support a means for receiving a second TB of the sidelink data during a second slot of the set of multiple slots, where the second TB of the sidelink data occupies a second AGC symbol of the second slot and a second gap symbol of the second slot.

In some examples, to support receiving the sidelink data, the sidelink data component 1040 may be configured as or otherwise support a means for receiving a first TB of the sidelink data during a first slot of the set of multiple slots, where the first TB of the sidelink data occupies the gap symbol of the first slot.

In some examples, the control signaling component 1045 may be configured as or otherwise support a means for receiving control signaling enabling sidelink data transmissions via the AGC symbol, the gap symbol, or both for multi-slot transmissions, where receiving the sidelink data is based on receiving the control signaling.

In some examples, the SCI component 1025 may be configured as or otherwise support a means for receiving, via a second slot of the set of multiple slots, a second SCI message enabling sidelink data transmissions via the AGC symbol, the gap symbol, or both for a multi-slot transmission associated with the set of multiple slots, where receiving the sidelink data is based on receiving the second SCI message.

In some examples, a first bit in the second SCI message corresponds to the AGC symbol, and a second bit in the second SCI message corresponds to the gap symbol.

In some examples, the SCI component 1025 may be configured as or otherwise support a means for receiving, via a second slot of the set of multiple slots, a second SCI message indicating a first MCS associated with a first TB of the sidelink data. In some examples, the TB component 1055 may be configured as or otherwise support a means for receiving the first TB via the second slot according to the first MCS.

In some examples, the control signaling component 1045 may be configured as or otherwise support a means for receiving control signaling configuring a sidelink resource pool including the sidelink resources, the sidelink resource pool corresponding to a quantity of consecutive slots equal to a quantity of slots of the set of multiple slots, where receiving the sidelink data via the set of multiple slots is based on the sidelink resource pool.

In some examples, the SCI component 1025 may be configured as or otherwise support a means for receiving, via a second slot of the set of multiple slots, an additional SCI message reserving a second set of multiple slots for retransmission of the sidelink data. In some examples, the feedback signaling component 1050 may be configured as or otherwise support a means for transmitting, based on receiving the sidelink data, feedback signaling indicating failed reception of a first TB and successful reception of a second TB of the sidelink data. In some examples, the TB component 1055 may be configured as or otherwise support a means for receiving a retransmission of the first TB via a first slot of the second set of multiple slots based on the feedback signaling.

In some examples, the slot monitoring component 1065 may be configured as or otherwise support a means for refraining from monitoring a second slot of the second set of multiple slots based on the feedback signaling.

In some examples, the TB component 1055 may be configured as or otherwise support a means for receiving a repetition of the first TB via a second slot of the second set of multiple slots based on the feedback signaling.

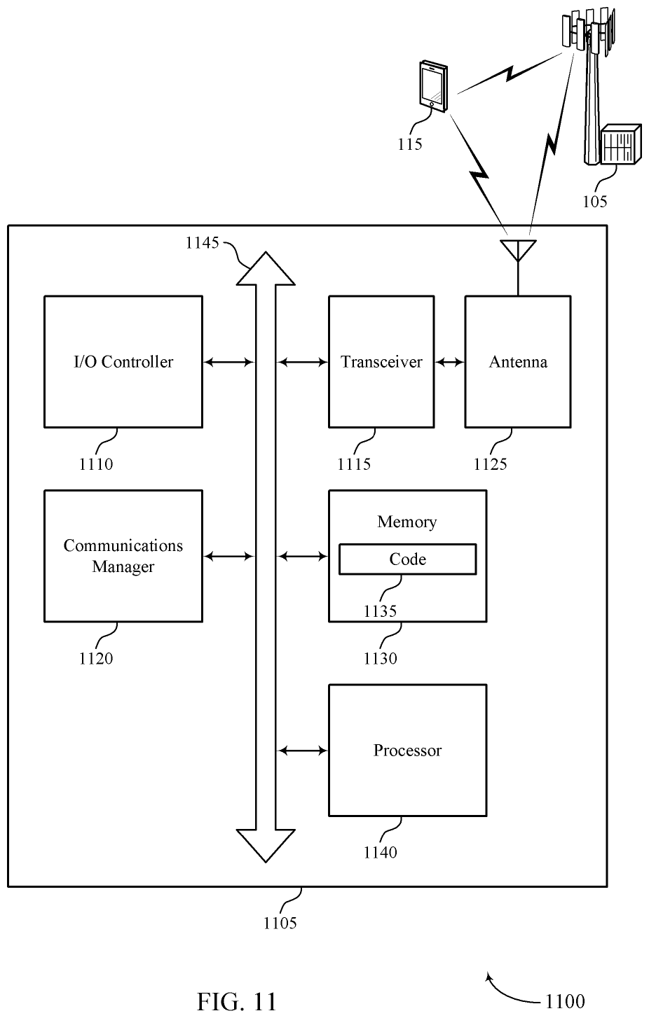

FIG. 11 illustrates a diagram of a system 1100 including a device 1105 that supports scheduling and resource reservation for multi-slot transmissions in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting scheduling and resource reservation for multi-slot transmissions). For example, the device 1105 or a component of the device 1105 may include a processor 1140 and memory 1130 coupled with or to the processor 1140, the processor 1140 and memory 1130 configured to perform various functions described herein.

For example, the communications manager 1120 may be configured as or otherwise support a means for transmitting, by a first UE to at least a second UE, a SCI message reserving sidelink resources across a set of multiple slots. The communications manager 1120 may be configured as or otherwise support a means for performing a LBT procedure prior to the set of multiple slots. The communications manager 1120 may be configured as or otherwise support a means for transmitting, based on the LBT procedure indicating that the reserved sidelink resources are available, sidelink data to at least the second UE via the set of multiple slots, where the sidelink data, or a CP associated with the sidelink data, or both, occupy at least one of a gap symbol of the set of multiple slots, or an AGC symbol of the set of multiple slots.

Additionally, or alternatively, the communications manager 1120 may support wireless communications in accordance with examples as disclosed herein. For example, the communications manager 1120 may be configured as or otherwise support a means for receiving, from a first UE by at least a second UE, a SCI message reserving sidelink resources across a set of multiple slots. The communications manager 1120 may be configured as or otherwise support a means for receiving, based on the SCI message, sidelink data via one or more of the set of multiple slots, where the sidelink data, or a CP associated with the sidelink data, or both, occupy at least one of a gap symbol of the set of multiple slots, or an AGC symbol of the set of multiple slots.

By including or configuring the communications manager 1120 in accordance with examples as described herein, the device 1105 may support techniques for scheduling and resource reservation for multi-slot transmissions, which may result in various advantages, such as improved communication reliability, reduced latency, improved user experience related to reduced processing, reduced power consumption, more efficient utilization of communication resources, improved coordination between devices, longer battery life, improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of scheduling and resource reservation for multi-slot transmissions as described herein, or the processor 1140 and the memory 1130 may be otherwise configured to perform or support such operations.

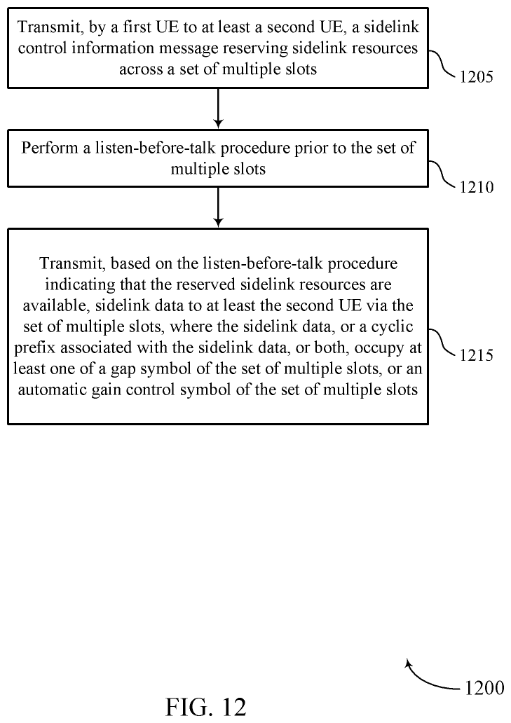

FIG. 12 illustrates a flowchart illustrating a method 1200 that supports scheduling and resource reservation for multi-slot transmissions in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include transmitting, by a first UE to at least a second UE, a SCI message reserving sidelink resources across a set of multiple slots. The operations of 1205 may be performed in accordance with examples as disclosed herein. In some examples, aspects of the operations of 1205 may be performed by an SCI component 1025 as described with reference to FIG. 10.

At 1210, the method may include performing a LBT procedure prior to the set of multiple slots. The operations of 1210 may be performed in accordance with examples as disclosed herein. In some examples, aspects of the operations of 1210 may be performed by an LBT component 1030 as described with reference to FIG. 10.

At 1215, the method may include transmitting, based on the LBT procedure indicating that the reserved sidelink resources are available, sidelink data to at least the second UE via the set of multiple slots, where the sidelink data, or a CP associated with the sidelink data, or both, occupy at least one of a gap symbol of the set of multiple slots, or an AGC symbol of the set of multiple slots. The operations of 1215 may be performed in accordance with examples as disclosed herein. In some examples, aspects of the operations of 1215 may be performed by a sidelink transmission component 1035 as described with reference to FIG. 10.

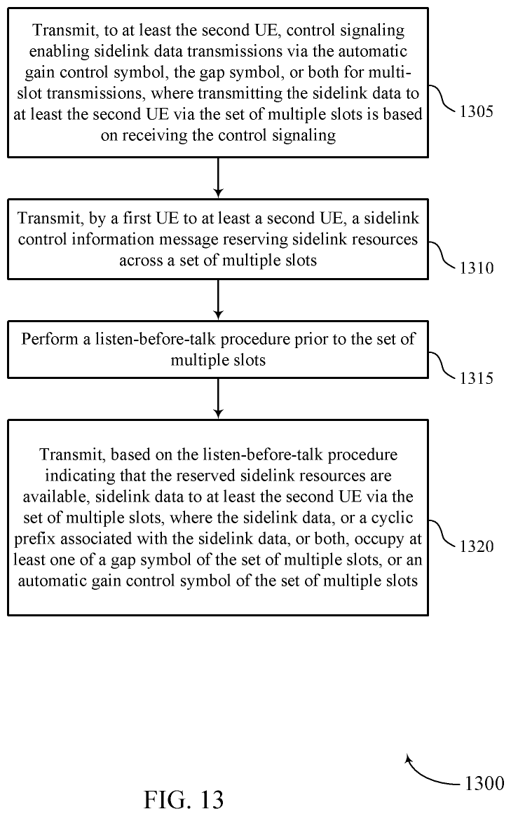

FIG. 13 illustrates a flowchart illustrating a method 1300 that supports scheduling and resource reservation for multi-slot transmissions in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include transmitting, to at least the second UE, control signaling enabling sidelink data transmissions via the AGC symbol, the gap symbol, or both for multi-slot transmissions, where transmitting the sidelink data to at least the second UE via the set of multiple slots is based on receiving the control signaling. The operations of 1305 may be performed in accordance with examples as disclosed herein. In some examples, aspects of the operations of 1305 may be performed by a control signaling component 1045 as described with reference to FIG. 10.

At 1310, the method may include transmitting, by a first UE to at least a second UE, a SCI message reserving sidelink resources across a set of multiple slots. The operations of 1310 may be performed in accordance with examples as disclosed herein. In some examples, aspects of the operations of 1310 may be performed by an SCI component 1025 as described with reference to FIG. 10.

At 1315, the method may include performing a LBT procedure prior to the set of multiple slots. The operations of 1315 may be performed in accordance with examples as disclosed herein. In some examples, aspects of the operations of 1315 may be performed by an LBT component 1030 as described with reference to FIG. 10.

At 1320, the method may include transmitting, based on the LBT procedure indicating that the reserved sidelink resources are available, sidelink data to at least the second UE via the set of multiple slots, where the sidelink data, or a CP associated with the sidelink data, or both, occupy at least one of a gap symbol of the set of multiple slots, or an AGC symbol of the set of multiple slots. The operations of 1320 may be performed in accordance with examples as disclosed herein. In some examples, aspects of the operations of 1320 may be performed by a sidelink transmission component 1035 as described with reference to FIG. 10.

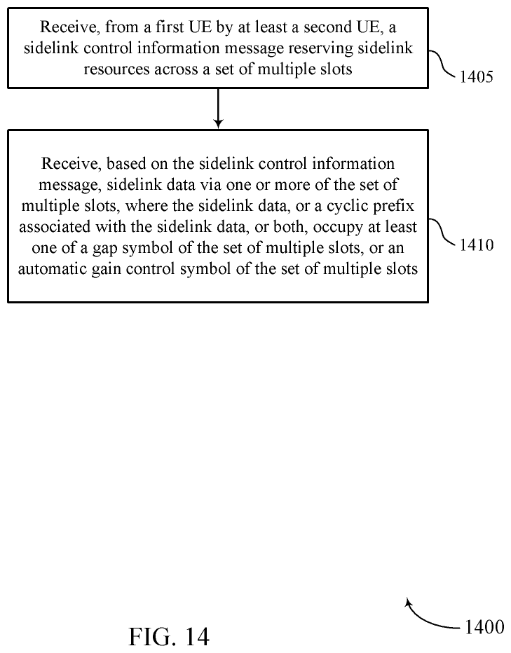

FIG. 14 illustrates a flowchart illustrating a method 1400 that supports scheduling and resource reservation for multi-slot transmissions in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include receiving, from a first UE by at least a second UE, a SCI message reserving sidelink resources across a set of multiple slots. The operations of 1405 may be performed in accordance with examples as disclosed herein. In some examples, aspects of the operations of 1405 may be performed by an SCI component 1025 as described with reference to FIG. 10.

At 1410, the method may include receiving, based on the SCI message, sidelink data via one or more of the set of multiple slots, where the sidelink data, or a CP associated with the sidelink data, or both, occupy at least one of a gap symbol of the set of multiple slots, or an AGC symbol of the set of multiple slots. The operations of 1410 may be performed in accordance with examples as disclosed herein. In some examples, aspects of the operations of 1410 may be performed by a sidelink transmission component 1035 as described with reference to FIG. 10.

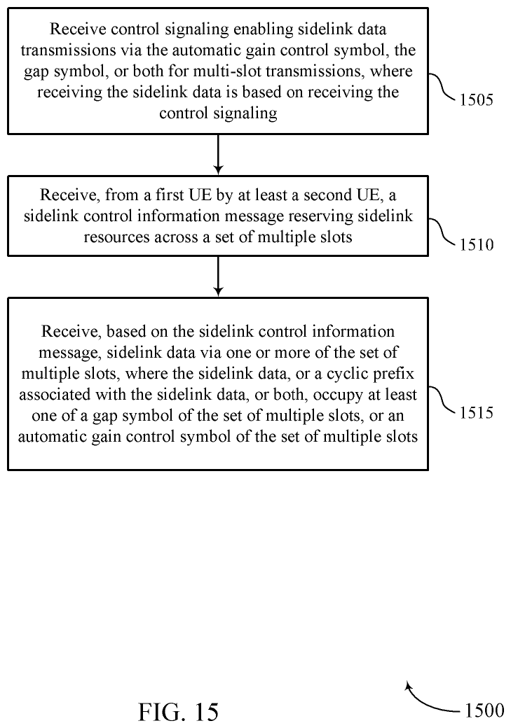

FIG. 15 illustrates a flowchart illustrating a method 1500 that supports scheduling and resource reservation for multi-slot transmissions in accordance with one or more aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1505, the method may include receiving control signaling enabling sidelink data transmissions via the AGC symbol, the gap symbol, or both for multi-slot transmissions, where receiving the sidelink data is based on receiving the control signaling. The operations of 1505 may be performed in accordance with examples as disclosed herein. In some examples, aspects of the operations of 1505 may be performed by a control signaling component 1045 as described with reference to FIG. 10.

At 1510, the method may include receiving, from a first UE by at least a second UE, a SCI message reserving sidelink resources across a set of multiple slots. The operations of 1510 may be performed in accordance with examples as disclosed herein. In some examples, aspects of the operations of 1510 may be performed by an SCI component 1025 as described with reference to FIG. 10.

At 1515, the method may include receiving, based on the SCI message, sidelink data via one or more of the set of multiple slots, where the sidelink data, or a CP associated with the sidelink data, or both, occupy at least one of a gap symbol of the set of multiple slots, or an AGC symbol of the set of multiple slots. The operations of 1515 may be performed in accordance with examples as disclosed herein. In some examples, aspects of the operations of 1515 may be performed by a sidelink transmission component 1035 as described with reference to FIG. 10. The following provides an overview of aspects of the present disclosure:

Aspect 1: A method for wireless communications comprising: transmitting, by a first UE to at least a second UE, a sidelink control information message reserving sidelink resources across a plurality of slots; performing a listen-before-talk procedure prior to the plurality of slots; and transmitting, based at least in part on the listen-before-talk procedure indicating that the reserved sidelink resources are available, sidelink data to at least the second UE via the plurality of slots, wherein the sidelink data, or a cyclic prefix associated with the sidelink data, or both, occupy at least one of a gap symbol of the plurality of slots, or an automatic gain control symbol of the plurality of slots.

Aspect 2: The method of aspect 1, wherein transmitting the sidelink data comprises: transmitting the sidelink data to the second UE during a first slot of the plurality of slots, wherein the cyclic prefix occupies the gap symbol of the first slot.

Aspect 3: The method of any of aspects 1 through 2, wherein transmitting the sidelink data comprises: transmitting a first transport block of the sidelink data to the second UE during a first slot of the plurality of slots, wherein the first transport block of the sidelink data occupies a first automatic gain control symbol of the first slot and a first gap symbol of the first slot; and transmitting a second transport block of the sidelink data to the second UE during a second slot of the plurality of slots, wherein the second transport block of the sidelink data occupies a second automatic gain control symbol of the second slot and a second gap symbol of the second slot.

Aspect 4: The method of any of aspects 1 through 3, wherein transmitting the sidelink data comprises: transmitting a first transport block of the sidelink data to the second UE during a first slot of the plurality of slots, wherein the first transport block of the sidelink data occupies a first gap symbol of the first slot; and transmitting a second transport block of the sidelink data to a third UE during a second slot of the plurality of slots, wherein the second transport block of the sidelink data occupies a second gap symbol of the second slot.

Aspect 5: The method of any of aspects 1 through 4, wherein transmitting the sidelink data comprises: transmitting a first transport block of the sidelink data to the second UE during a first slot of the plurality of slots, wherein the first transport block of the sidelink data occupies a first gap symbol of the first slot and a first automatic gain control symbol of the first slot; and transmitting a second transport block of the sidelink data to a third UE during a second slot of the plurality of slots, wherein the second transport block of the sidelink data occupies a second gap symbol of the second slot and a second automatic gain control symbol of the second slot.

Aspect 6: The method of any of aspects 1 through 5, further comprising: transmitting, to at least the second UE, control signaling enabling sidelink data transmissions via the automatic gain control symbol, the gap symbol, or both for multi-slot transmissions, wherein transmitting the sidelink data to at least the second UE via the plurality of slots is based at least in part on receiving the control signaling.

Aspect 7: The method of any of aspects 1 through 6, further comprising: transmitting, via a second slot of the plurality of slots, a second sidelink control information message enabling sidelink data transmissions via the automatic gain control symbol, the gap symbol, or both for a multi-slot transmission associated with the plurality of slots, wherein transmitting the sidelink data to at least the second UE via the plurality of slots is based at least in part on receiving the second sidelink control information message.

Aspect 8: The method of aspect 7, wherein a first bit in the second sidelink control information message corresponds to the automatic gain control symbol, and a second bit in the second sidelink control information message corresponds to the gap symbol.

Aspect 9: The method of any of aspects 1 through 8, further comprising: transmitting, via a second slot of the plurality of slots, a second sidelink control information message indicating a first modulation and coding scheme associated with a first transport block of the sidelink data.

Aspect 10: The method of aspect 9, wherein transmitting the sidelink data comprises: transmitting the first transport block to the second UE via the second slot according to the first modulation and coding scheme; and transmitting a second transport block to a third UE via a third slot of the plurality of slots according to a second modulation and coding scheme that is based at least in part on the first modulation and coding scheme, a first quantity of resource elements associated with the first transport block, and a second quantity of resource elements associated with the second transport block.

Aspect 11: The method of any of aspects 1 through 10, wherein transmitting the sidelink data comprises: transmitting a first transport block to the second UE via a second slot of the plurality of slots according to a first modulation and coding scheme; and transmitting the first transport block to a third UE via the second slot according to a second modulation and coding scheme.

Aspect 12: The method of any of aspects 1 through 11, further comprising: receiving control signaling configuring a sidelink resource pool comprising the sidelink resources, the sidelink resource pool corresponding to a quantity of consecutive slots equal to a quantity of slots of the plurality of slots, wherein transmitting the sidelink data via the plurality of slots is based at least in part on the sidelink resource pool.

Aspect 13: The method of any of aspects 1 through 12, further comprising: transmitting, via a second slot of the plurality of slots, an additional sidelink control information message reserving a second plurality of slots for retransmission of the sidelink data; receiving, based at least in part on transmitting the sidelink data, feedback signaling indicating failed reception of a first transport block of the sidelink data and successful reception of a second transport block of the sidelink data; and retransmitting the first transport block via a first slot of the second plurality of slots based at least in part on the feedback signaling.

Aspect 14: The method of aspect 13, further comprising: discarding, for sidelink signaling, a second slot of the second plurality of slots based at least in part on the feedback signaling.

Aspect 15: The method of any of aspects 13 through 14, further comprising: transmitting a repetition of the first transport block via a second slot of the second plurality of slots based at least in part on the feedback signaling.

Aspect 16: The method of any of aspects 13 through 15, further comprising: transmitting a third transport block via a second slot of the second plurality of slots based at least in part on the feedback signaling.

Aspect 17: A method for wireless communications, comprising: receiving, from a first UE by at least a second UE, a sidelink control information message reserving sidelink resources across a plurality of slots; and receiving, based at least in part on the sidelink control information message, sidelink data via one or more of the plurality of slots, wherein the sidelink data, or a cyclic prefix associated with the sidelink data, or both, occupy at least one of a gap symbol of the plurality of slots, or an automatic gain control symbol of the plurality of slots.

Aspect 18: The method of aspect 17, wherein receiving the sidelink data comprises: receiving the sidelink data during a first slot of the plurality of slots, wherein the cyclic prefix occupies the gap symbol of the first slot.

Aspect 19: The method of any of aspects 17 through 18, wherein receiving the sidelink data comprises: receiving a first transport block of the sidelink data during a first slot of the plurality of slots, wherein the first transport block of the sidelink data occupies a first automatic gain control symbol of the first slot and a first gap symbol of the first slot; and receiving a second transport block of the sidelink data during a second slot of the plurality of slots, wherein the second transport block of the sidelink data occupies a second automatic gain control symbol of the second slot and a second gap symbol of the second slot.

Aspect 20: The method of any of aspects 17 through 19, wherein receiving the sidelink data comprises: receiving a first transport block of the sidelink data during a first slot of the plurality of slots, wherein the first transport block of the sidelink data occupies the gap symbol of the first slot.

Aspect 21: The method of any of aspects 17 through 20, further comprising: receiving control signaling enabling sidelink data transmissions via the automatic gain control symbol, the gap symbol, or both for multi-slot transmissions, wherein receiving the sidelink data is based at least in part on receiving the control signaling.

Aspect 22: The method of any of aspects 17 through 21, further comprising: receiving, via a second slot of the plurality of slots, a second sidelink control information message enabling sidelink data transmissions via the automatic gain control symbol, the gap symbol, or both for a multi-slot transmission associated with the plurality of slots, wherein receiving the sidelink data is based at least in part on receiving the second sidelink control information message.

Aspect 23: The method of aspect 22, wherein a first bit in the second sidelink control information message corresponds to the automatic gain control symbol, and a second bit in the second sidelink control information message corresponds to the gap symbol.

Aspect 24: The method of any of aspects 17 through 23, further comprising: receiving, via a second slot of the plurality of slots, a second sidelink control information message indicating a first modulation and coding scheme associated with a first transport block of the sidelink data; and receiving the first transport block via the second slot according to the first modulation and coding scheme.

Aspect 25: The method of any of aspects 17 through 24, further comprising: receiving control signaling configuring a sidelink resource pool comprising the sidelink resources, the sidelink resource pool corresponding to a quantity of consecutive slots equal to a quantity of slots of the plurality of slots, wherein receiving the sidelink data via the plurality of slots is based at least in part on the sidelink resource pool.

Aspect 26: The method of any of aspects 17 through 25, further comprising: receiving, via a second slot of the plurality of slots, an additional sidelink control information message reserving a second plurality of slots for retransmission of the sidelink data; transmitting, based at least in part on receiving the sidelink data, feedback signaling indicating failed reception of a first transport block and successful reception of a second transport block of the sidelink data; and receiving a retransmission of the first transport block via a first slot of the second plurality of slots based at least in part on the feedback signaling.

Aspect 27: The method of aspect 26, further comprising: refraining from monitoring a second slot of the second plurality of slots based at least in part on the feedback signaling.

Aspect 28: The method of any of aspects 26 through 27, further comprising: receiving a repetition of the first transport block via a second slot of the second plurality of slots based at least in part on the feedback signaling.

Aspect 29: An apparatus comprising a processor; memory coupled with the processor; and instructions stored in the memory and executable by the processor to cause the apparatus to perform a method of any of aspects 1 through 16.

Aspect 30: An apparatus comprising at least one means for performing a method of any of aspects 1 through 16.

Aspect 31: A non-transitory computer-readable medium storing code the code comprising instructions executable by a processor to perform a method of any of aspects 1 through 16.

Aspect 32: An apparatus for wireless communications, comprising a processor; memory coupled with the processor; and instructions stored in the memory and executable by the processor to cause the apparatus to perform a method of any of aspects 17 through 28.

Aspect 33: An apparatus for wireless communications, comprising at least one means for performing a method of any of aspects 17 through 28.

Aspect 34: A non-transitory computer-readable medium storing code for wireless communications, the code comprising instructions executable by a processor to perform a method of any of aspects 17 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus, comprising:
a processor;
memory coupled with the processor; and
instructions stored in the memory and executable by the processor to cause the apparatus to:
transmit, by a first user equipment (UE) to at least a second UE, a sidelink control information message reserving sidelink resources across a plurality of slots;
perform a listen-before-talk procedure prior to the plurality of slots; and
transmit, based at least in part on the listen-before-talk procedure indicating that the reserved sidelink resources are available, sidelink data to at least the second UE via the plurality of slots, wherein the sidelink data, or a cyclic prefix associated with the sidelink data, or both, occupy at least one of a gap symbol of the plurality of slots, or an automatic gain control symbol of the plurality of slots.

2. The apparatus of claim 1., wherein the instructions to transmit the sidelink data are executable by the processor to cause the apparatus to:
transmit the sidelink data to the second UE during a first slot of the plurality of slots, wherein the cyclic prefix occupies the gap symbol of the first slot.

3. The apparatus of claim 1, wherein the instructions to transmit the sidelink data are executable by the processor to cause the apparatus to:
transmit a first transport block of the sidelink data to the second UE during a first slot of the plurality of slots, wherein the first transport block of the sidelink data occupies a first automatic gain control symbol of the first slot and a first gap symbol of the first slot; and
transmit a second transport block of the sidelink data to the second UE during a second slot of the plurality of slots, wherein the second transport block of the sidelink data occupies a second automatic gain control symbol of the second slot and a second gap symbol of the second slot.

4. The apparatus of claim 1, wherein the instructions to transmit the sidelink data are executable by the processor to cause the apparatus to:
transmit a first transport block of the sidelink data to the second UE during a first slot of the plurality of slots, wherein the first transport block of the sidelink data occupies a first gap symbol of the first slot; and
transmit a second transport block of the sidelink data to a third UE during a second slot of the plurality of slots, wherein the second transport block of the sidelink data occupies a second gap symbol of the second slot.

5. The apparatus of claim 1, wherein the instructions to transmit the sidelink data are executable by the processor to cause the apparatus to:
transmit a first transport block of the sidelink data to the second UE during a first slot of the plurality of slots, wherein the first transport block of the sidelink data occupies a first gap symbol of the first slot and a first automatic gain control symbol of the first slot; and
transmit a second transport block of the sidelink data to a third UE during a second slot of the plurality of slots, wherein the second transport block of the sidelink data occupies a second gap symbol of the second slot and a second automatic gain control symbol of the second slot.

6. The apparatus of claim 1, wherein the instructions are further executable by the processor to cause the apparatus to:
transmit, to at least the second UE, control signaling enabling sidelink data transmissions via the automatic gain control symbol, the gap symbol, or both for multi-slot transmissions, wherein transmitting the sidelink data to at least the second UE via the plurality of slots is based at least in part on receiving the control signaling.

7. The apparatus of claim 1, wherein the instructions are further executable by the processor to cause the apparatus to:
transmit, via a second slot of the plurality of slots, a second sidelink control information message enabling sidelink data transmissions via the automatic gain control symbol, the gap symbol, or both for a multi-slot transmission associated with the plurality of slots, wherein transmitting the sidelink data to at least the second UE via the plurality of slots is based at least in part on receiving the second sidelink control information message.

8. The apparatus of claim 7, wherein a first bit in the second sidelink control information message corresponds to the automatic gain control symbol, and a second bit in the second sidelink control information message corresponds to the gap symbol.

9. The apparatus of claim 1, wherein the instructions are further executable by the processor to cause the apparatus to:
transmit, via a second slot of the plurality of slots, a second sidelink control information message indicating a first modulation and coding scheme associated with a first transport block of the sidelink data.

10. The apparatus of claim 9, wherein the instructions to transmit the sidelink data are executable by the processor to cause the apparatus to:
transmit the first transport block to the second UE via the second slot according to the first modulation and coding scheme; and
transmit a second transport block to a third UE via a third slot of the plurality of slots according to a second modulation and coding scheme that is based at least in part on the first modulation and coding scheme, a first quantity of resource elements associated with the first transport block, and a second quantity of resource elements associated with the second transport block.

11. The apparatus of claim 1, wherein the instructions to transmit the sidelink data are executable by the processor to cause the apparatus to:
transmit a first transport block to the second UE via a second slot of the plurality of slots according to a first modulation and coding scheme; and
transmit the first transport block to a third UE via the second slot according to a second modulation and coding scheme.

12. The apparatus of claim 1, wherein the instructions are further executable by the processor to cause the apparatus to:
receive control signaling configuring a sidelink resource pool comprising the sidelink resources, the sidelink resource pool corresponding to a quantity of consecutive slots equal to a quantity of slots of the plurality of slots, wherein transmitting the sidelink data via the plurality of slots is based at least in part on the sidelink resource pool.

13. The apparatus of claim 1, wherein the instructions are further executable by the processor to cause the apparatus to:
transmit, via a second slot of the plurality of slots, an additional sidelink control information message reserving a second plurality of slots for retransmission of the sidelink data;
receive, based at least in part on transmitting the sidelink data, feedback signaling indicating failed reception of a first transport block of the sidelink data and successful reception of a second transport block of the sidelink data; and
retransmit the first transport block via a first slot of the second plurality of slots based at least in part on the feedback signaling.

14. The apparatus of claim 13, wherein the instructions are further executable by the processor to cause the apparatus to:
discard, for sidelink signaling, a second slot of the second plurality of slots based at least in part on the feedback signaling.

15. The apparatus of claim 13, wherein the instructions are further executable by the processor to cause the apparatus to:
transmit a repetition of the first transport block via a second slot of the second plurality of slots based at least in part on the feedback signaling.

16. The apparatus of claim 13, wherein the instructions are further executable by the processor to cause the apparatus to:
transmit a third transport block via a second slot of the second plurality of slots based at least in part on the feedback signaling.

17. An apparatus for wireless communications, comprising:
a processor;
memory coupled with the processor; and
instructions stored in the memory and executable by the processor to cause the apparatus to:
receive, from a first user equipment (UE) by at least a second UE, a sidelink control information message reserving sidelink resources across a plurality of slots; and
receive, based at least in part on the sidelink control information message, sidelink data via one or more of the plurality of slots, wherein the sidelink data, or a cyclic prefix associated with the sidelink data, or both, occupy at least one of a gap symbol of the plurality of slots, or an automatic gain control symbol of the plurality of slots.

18. The apparatus of claim 17, wherein the instructions to receive the sidelink data are executable by the processor to cause the apparatus to:
receive the sidelink data during a first slot of the plurality of slots, wherein the cyclic prefix occupies the gap symbol of the first slot.

19. The apparatus of claim 17, wherein the instructions to receive the sidelink data are executable by the processor to cause the apparatus to:
receive a first transport block of the sidelink data during a first slot of the plurality of slots, wherein the first transport block of the sidelink data occupies a first automatic gain control symbol of the first slot and a first gap symbol of the first slot; and
receive a second transport block of the sidelink data during a second slot of the plurality of slots, wherein the second transport block of the sidelink data occupies a second automatic gain control symbol of the second slot and a second gap symbol of the second slot.

20. The apparatus of claim 17, wherein the instructions to receive the sidelink data are executable by the processor to cause the apparatus to:
receive a first transport block of the sidelink data during a first slot of the plurality of slots, wherein the first transport block of the sidelink data occupies the gap symbol of the first slot.

21-30. (canceled)
